(19) United States
(12) Patent Application Publication
(10) Pub. No.: US 2010/0157255 A1
(43) Pub. Date: Jun. 24, 2010

(54) Projection optical system and visual display apparatus using the same

(76) Inventor: Takayoshi Togino, Koganei-shi (JP)

Correspondence Address: Richard M. Rosati, Esq.;Kenyon & Kenyon LLP, One Broadway, New York, NY, 10004, US

(21) Appl. No.: 12/653,233

(22) Filed: Dec. 10, 2009

(30) Foreign Application Priority Data
Dec. 16, 2008 (JP) 2008-319390
Oct. 6, 2009 (JP) 2009-232155

(51) Int. Cl. G03B 21/14

(52) U.S. Cl. 353/69

(57) ABSTRACT

In a projection optical system 4 for projecting an image being displayed on an image display element 3, the display surface of the image display element 3 and the projection surface of the projection optical system 4 are decentered in the Y-Z cross section and the projection surface is formed by means of a circular-arc-shaped curved surface with the chord thereof directed to the side of the projection optical system 4 in the X-Z cross section and the projection optical system 4 has at least a rotationally asymmetric corrective optical surface 5 for correcting the distortion of the image.

### BACKGROUND OF THE INVENTION AND RELATED ART STATEMENT

The present invention relates to a projection optical system and a visual display apparatus using such a system. More particularly, the present invention relates to a projection optical system and a visual display apparatus using such a system that can display an image with a wide view angle.

Known optical systems for observing a virtual image by means of an eyepiece optical system and a projection optical system include those described in JP-A-6-294943 (Patent Document 1), JP-A-7-134266 (Patent Document 2), JP-A-6-319092 (Patent Document 3), JP-A-2004-98834 (Patent Document 4), JP-A-2004-226997 (Patent Document 5) and JP-A-2009-58754 (Patent Document 6).

### SUMMARY OF THE INVENTION

A projection optical system for projecting an image being displayed on an image display element according to an aspect of the present invention is comprising,

a projection surface of the projection optical system is formed by means of a circular-arc-shaped curved surface having a center line at the side of the projection optical system in an X-Z cross section and at least a rotationally asymmetric corrective optical surface that corrects the distortion of the image on the projection surface is provided, wherein a display surface of the image display element and a projection surface of the projection optical system are decentered in a Y-Z cross section.

Preferably, a projection optical system as defined above is further wherein the display surface and the projection surface are in parallel with each other and shifted and decentered in the Y-Z cross section and the corrective optical surface corrects the bow-like image distortion that arises due to the cylindrical projection surface to which the flux of light is projected obliquely in the Y-Z cross section.

Preferably, a projection optical system as defined above is further wherein the angle of the corrective optical surface changes symmetrically relative to the Y-Z cross section as the corrective optical surface is moved away from the Y-Z cross section in the positive direction and the negative direction along the X-axis.

Preferably, a projection optical system as defined above is further wherein the corrective optical surface directs rays of light toward the opposite side relative to the central axis of the projection optical system as the corrective optical surface moves away from the Y-Z cross section in the positive direction and the negative direction along the X-axis to correct the bow-like image distortion that arises with the chord thereof facing the central axis side of the projection optical system and the circular arc thereof facing the opposite relative to the central axis of the projection optical system in the X-Y plane.

Preferably, a projection optical system as defined above is further wherein it gives a C8 term (x²y term) when the corrective optical surface is formed by means of a free-form surface defined by formula (a) represented below:

$$Z = ( {r}^{2} / R ) / [ 1 + √ \{ 1 - ( 1 + k ) {( r / R )}^{2} \} ] + {\sum }_{j = 1}^{∞} {C}_{j} {X}^{m} {Y}^{n} , \qquad ( a )$$

where R: radius of curvature at the vertex,

k: conic constant and

r=√(X²+Y²).

Preferably, a projection optical system as defined above is further wherein the display surface and the projection surface are tilted and decentered to form an angle in the Y-Z cross section and the corrective optical surface has at least two rotationally asymmetric surfaces for correcting the image distortion on the projection surface.

Preferably, a projection optical system as defined above is further wherein the at least two corrective optical surfaces correct the bow-like image distortion and the trapezoidal imaging distortion that arise when the angle between the surfaces changes as the surfaces moves away from the Y-Z cross section in the positive direction and the negative direction of the X-axis.

Preferably, a projection optical system as defined above is further wherein the corrective optical surface has at least two surfaces for correcting rays of light in the opposite directions toward the positive direction and the negative direction of the Y-axis as the corrective optical surface moves away from the Y-Z surface in the positive direction and the negative direction of the X-axis to correct simultaneously the bow-like image distortion and the trapezoidal imaging distortion.

Preferably, a projection optical system as defined above is further wherein the at least two corrective optical surfaces give a C8 term (x²y term) when the corrective optical surfaces are formed by means of respective free-form surfaces defined by formula (a) represented below:

$$Z = ( {r}^{2} / R ) / [ 1 + √ \{ 1 - ( 1 + k ) {( r / R )}^{2} \} ] + {\sum }_{j = 1}^{∞} {C}_{j} {X}^{m} {Y}^{n} , \qquad ( a )$$

where R: radius of curvature at the vertex,

k: conic constant and

r=√(X²+Y²).

In another aspect of the present invention, there is provided a visual display apparatus wherein it includes a projection optical system as defined above, a diffusion surface arranged near the image projected by the projection optical system, and an eyepiece optical system having positive reflection power for a remote virtual image that is the image projected by the eyepiece optical system, the image projected by the eyepiece optical system, diffusion surface and the projection optical system being arranged so as to draw a circular arc at an arbitrary position in a plane orthogonal relative to the common axis of rotational symmetry.

Preferably, a visual display apparatus as defined above is further wherein it satisfies the conditional formula (1) represented below:

400<R (1),

where R is the radius of curvature of the part (near the visual axis) of the eyepiece optical system that the central main ray of light from the projection optical system strikes.

Preferably, a visual display apparatus as defined above is further wherein the diffusion surface is toric-surface-shaped.

Preferably, a visual display apparatus as defined above is further wherein the eyepiece optical system is a spherical surface.

Preferably, a visual display apparatus as defined above is further wherein the eyepiece optical system is a toric surface.

Preferably, a visual display apparatus as defined above is further wherein the corrective optical surface is formed by a light transmitting element.

Preferably, a visual display apparatus as defined above is further wherein the light transmitting element has a free-form surface.

Still other objects and advantages of the invention will in part be obvious and will in part be apparent from the specification.

The invention accordingly includes the features of construction, combinations of elements and arrangement of parts which will be exemplified in the construction hereinafter set forth and the scope of the invention will be indicated in the claims.

### BRIEF DESCRIPTION OF THE DRAWINGS

FIG. 1 is a schematic cross-sectional view of a visual display apparatus according to the present invention;

FIG. 2 is a schematic plan view corresponding to FIG. 1;

FIG. 3 is a schematic illustration of an application where a visual display apparatus according to the present invention and a seat are combined;

FIG. 4 is a schematic illustration of the coordinate system of an embodiment of visual display apparatus according to the present invention;

FIG. 5 is a schematic cross-sectional view of the visual display apparatus of Example 1 of the present invention taken along the optical axis thereof;

FIG. 6 is a schematic plan view corresponding to FIG. 5;

FIG. 7 is a schematic illustration of the shape of the free-form surface of the image distortion correcting element of Example 1;

FIG. 8 is a schematic cross-sectional view of the visual display apparatus of Example 2 of the present invention taken along the optical axis thereof;

FIG. 9 is a schematic plan view corresponding to FIG. 8;

FIG. 10 is a schematic illustration of the shape of the free-form surface of the image distortion correcting element of Example 2;

FIG. 11 is a schematic cross-sectional view of the visual display apparatus of Example 3 of the present invention taken along the optical axis thereof;

FIG. 12 is a schematic plan view corresponding to FIG. 11;

FIG. 13 is a schematic illustration of the shape of the free-form surface as the first surface of the image distortion correcting element of Example 3;

FIG. 14 is a schematic cross-sectional view of the visual display apparatus of Example 4 of the present invention taken along the optical axis thereof;

FIG. 15 is a schematic plan view corresponding to FIG. 14;

FIG. 16 is a schematic illustration of the image distortion of Example 1;

FIG. 17 is a schematic illustration of the image distortion of Example 2;

FIG. 18 is a schematic illustration of the image distortion of Example 3;

FIG. 19 is a schematic illustration of the image distortion of Example 4;

FIG. 20 is a schematic illustration of the image distortion when no image distortion correcting element is provided;

FIG. 21 is a schematic cross-sectional view of a visual display apparatus using a projection optical system other than an ideal lens;

FIG. 22 is a schematic plan view corresponding to FIG. 21;

FIG. 23 is a schematic cross-sectional view of the projection optical system 4, the image distortion correcting element 5 and the diffusion member 6 of Example 5 taken along the axis of rotational symmetry 42;

FIG. 24 is a schematic plan view corresponding to FIG. 23;

FIG. 25 is a schematic illustration of the free-form surface of the first surface 51 of the first image distortion correcting element 5a of Example 5;

FIG. 26 is a schematic illustration of the free-form surface of the first surface 53 of the second image distortion correcting element 5b of Example 5;

FIG. 27 is a schematic illustration of the aberrations of Example 5;

FIG. 28 is a schematic illustration of the aberrations of Example 5;

FIG. 29 is a schematic illustration of the image distortion of Example 5;

FIG. 30 is a schematic cross-sectional view of the projection optical system 4, the image distortion correcting element 5 and the diffusion member 6 of Example 6 taken along the axis of rotational symmetry 42;

FIG. 31 is a schematic plan view corresponding to FIG. 30;

FIG. 32 is a schematic illustration of the free-form surface of the first surface 51 of the first image distortion correcting element 5a of Example 6;

FIG. 33 is a schematic illustration of the free-form surface of the first surface 53 of the second image distortion correcting element 5b of Example 6;

FIG. 34 is a schematic illustration of the aberrations of Example 6;

FIG. 35 is a schematic illustration of the aberrations of Example 6;

FIG. 36 is a schematic illustration of the image distortion of Example 6;

FIG. 37 is a schematic cross-sectional view of the projection optical system 4, the image distortion correcting element 5 and the diffusion member 6 of Example 7 taken along the axis of rotational symmetry 42;

FIG. 38 is a schematic plan view corresponding to FIG. 37;

FIG. 39 is a schematic illustration of the free-form surface of the first surface 51 of the first image distortion correcting element 5a of Example 7;

FIG. 40 is a schematic illustration of the free-form surface of the first surface 53 of the second image distortion correcting element 5b of Example 7;

FIG. 41 is a schematic illustration of the aberrations of Example 7;

FIG. 42 is a schematic illustration of the aberrations of Example 7;

FIG. 43 is a schematic illustration of the image distortion of Example 7;

FIG. 44 is a schematic cross-sectional view of the projection optical system 4, the image distortion correcting element 5 and the diffusion member 6 of Example 8 taken along the axis of rotational symmetry 42;

FIG. 45 is a schematic plan view corresponding to FIG. 44;

FIG. 46 is a schematic illustration of the free-form surface of the first surface 51 of the first image distortion correcting element 5a of Example 8;

FIG. 47 is a schematic illustration of the free-form surface of the first surface 53 of the second image distortion correcting element 5b of Example 8;

FIG. 48 is a schematic illustration of the aberrations of Example 8;

FIG. 49 is a schematic illustration of the aberrations of Example 8; and

FIG. 50 is a schematic illustration of the image distortion of Example 8.

### DESCRIPTION OF EXEMPLARY EMBODIMENTS

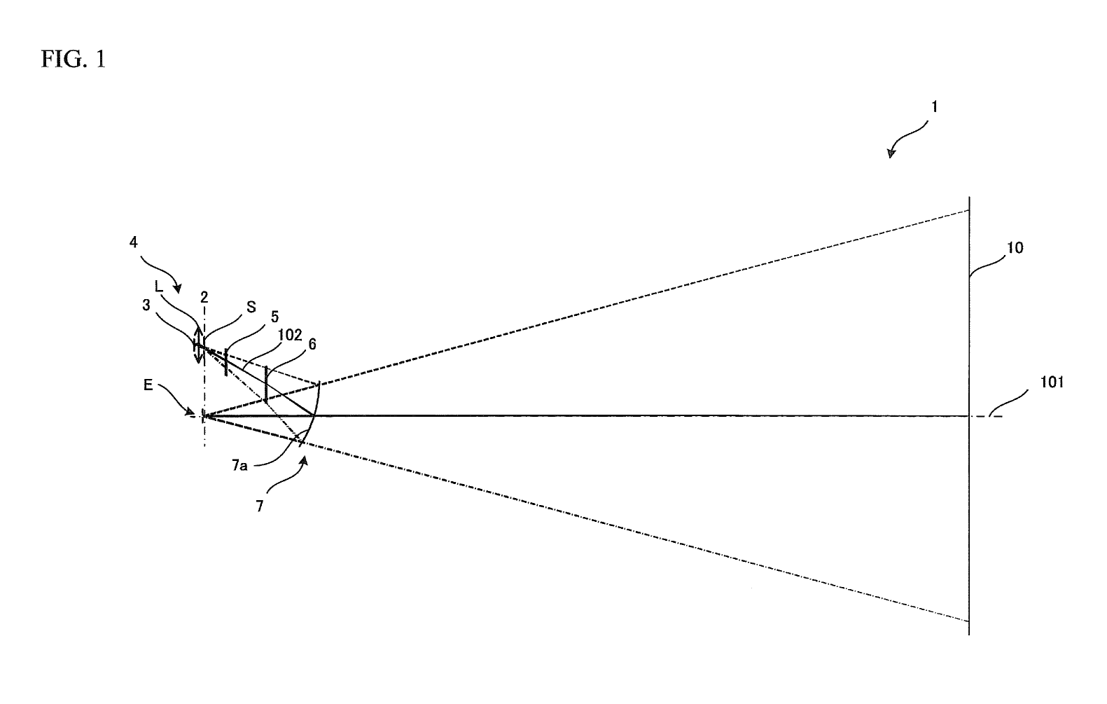

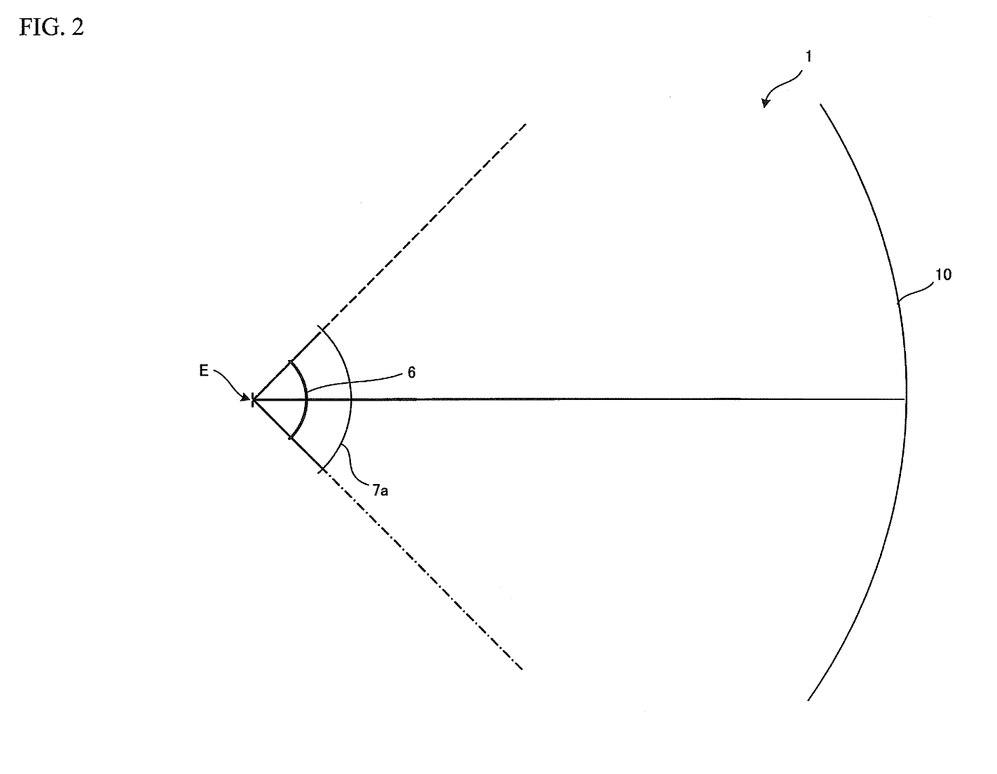

Now, a projection optical system and a visual display apparatus using such a projection optical system according to the present invention will be described further in terms of examples. FIG. 1 is a conceptual illustration of a visual display apparatus 1 according to the present invention and FIG. 2 is a schematic plan view corresponding to FIG. 1.

As illustrated in FIGS. 1 and 2, the visual display apparatus 1 according to the present invention includes an image display element 3, a projection optical system 4 for projecting the image displayed on the image display element 3, an image distortion correcting element 5, a diffusion member 6 arranged near the image projected by the projection optical system 4 and an eyepiece optical system 7 having positive reflection power for a remote virtual image 10 that is the image projected by the projection optical system 4 and the image projected by the eyepiece optical system 7, the diffusion member 6 and the projection optical system 4 is arranged so as to draw a circular arc at an arbitrary position in a plane orthogonal relative to a common axis of rotational symmetry 2, while the image distortion correcting element 5 that operates as corrective optical surface corrects the bow-like image distortion of the virtual image 10 to be observed by way of the eyepiece optical system 7.

Arrangements for providing an image with a wide view angle by way of an eyepiece optical system, relaying the image on a small display element to the front side focal position of the eyepiece optical system by means of a relay optical system are known. But the known arrangements are accompanied by a problem that the projection optical system is complex and large because the combined focal length of the projection optical system and the eyepiece optical system becomes very short and the NA of the projection optical system at the side of the image display element should be made very large to achieve a wide exit pupil by means of the eyepiece optical system.

In view of the above-identified problem, the present invention makes it possible to achieve a large entrance pupil by arranging a diffusion member 6 that is highly diffusive near the image projected by the projection optical system 4 to diffuse the projected image by the diffusion member 6 so that the image can be observed constantly if the viewer moves to a some extent.

Preferably, when the image is to be observed by the two eyes, or the left and right eyes, the diffusion member 6 is made cylindrical or conical. This is a requirement to be met in order to keep the convergence of the two eyeballs of the observer constant. When the diffusion member 6 is spherical, the distance from the concave mirror changes as a function of the vertical angle of view of the image being observed and a double image can be produced if the range within which the two eyes can achieve fusion is exceeded. Preferably, the diffusion surface of the diffusion member 6 is a toric surface.

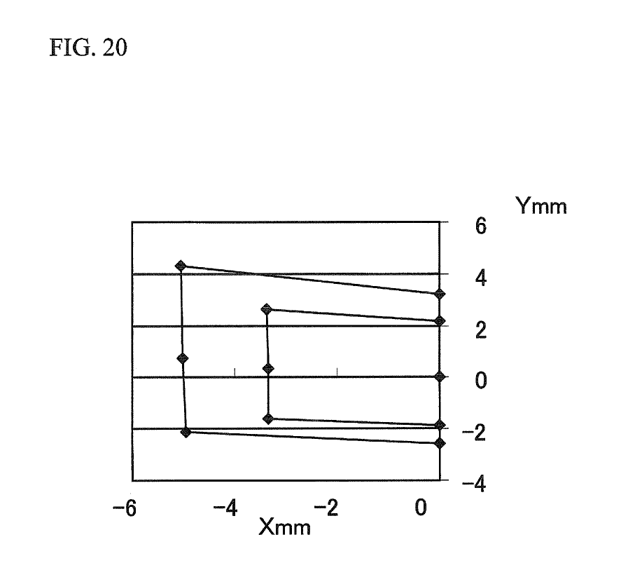

An eyepiece optical system 7 that provides a very wide view angle to an observer gives rise to a strong curvature of image. It is preferable that the eyepiece optical system 7 and the diffusion member 6 are rotationally symmetric relative to a same axis in order to correct it. However, when an image is projected by a projection optical system 4 from an oblique position that is decentered toward a curved diffusion member 6 (projection surface) as in the case of the present invention, there arises a problem where a bow-like image distortion and a trapezoidal image distortion take place as illustrated in FIG. 20. In FIG. 20, the outer quasi-quadrilateral represents the distortion of the image plane with the greatest image height while the inner quasi-quadrilateral represents the distortion of the image plane with the greatest image height×0.7. Generally, the trapezoidal image distortion is corrected by an electric image distortion correcting circuit but the bow-like image distortion is not corrected at all. According to the present invention, the bow-like image distortion is also corrected by means of an image distortion correcting element 5 that is dedicated to correction of bow-like image distortion.

Preferably, the conditional formula (1) represented below is satisfied:

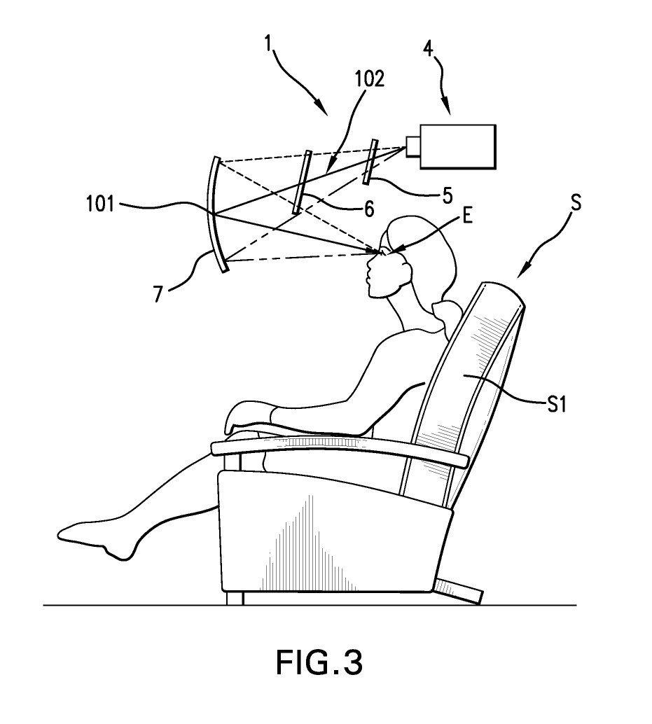

400<R (1),

where R is the radius of curvature of the part (near the visual axis 101) of the eyepiece optical system that the central main ray of light 102 (FIG. 3) from the projection optical system strikes.

In the case of an optical system for observing a virtual image projected by a set of eyepiece optical system 7 by means of two eyes, distortion takes place in the images to be observed by the left and right eyes due to the aberrations of the concave mirror when the reflection surface 7a becomes small. Then, there arises a problem of angle of views in which the images observed by the two eyes cannot be fused. The spacing of the two eyes of a human being is generally between 55 and 65 mm and the radius of curvature of the reflection surface 7a of the eyepiece position 7 that allows fusion of images within the above range of eye-spacing is minimally 400 mm. No fusion can take place blow this lower limit.

Preferably, the diffusion member 6 has a linear profile in the meridional cross section.

The projected image that is projected on the diffusion member 6 is diffused and reflected by the eyepiece optical system 7 before getting to the left and right eyes of the observer. When the projected image that is projected on the diffusion member 6 is curved in the meridional cross section, the angle of convergence of the rays of light entering the two eyes of the observer differs between the upward direction and the downward direction of the image being observed. Then, the two eyes can no longer achieve fusion and a double image is observed by the observer. Preferably, the projection surface is made cylindrical and the diffusion member 6 is also made cylindrical from the viewpoint of preparation. Preferably, the diffusion surface of the diffusion member 6 is a toric surface.

Preferably, the eyepiece optical system 7 is a spherical surface.

When the eyepiece optical system 7 is formed by means of a spherical surface, an existing plastic ball can be used for it to improve the preparation process thereof so that it can be manufactured at low cost. Alternatively, the reflection surface of the concave mirror may be formed by means of the inner surface of a plastic ball to make the concave mirror a front surface mirror or it may be formed by means of the outer surface of a plastic ball to make the concave mirror a rear surface mirror.

Still preferably, the eyepiece optical system 7 is a toric surface.

When the eyepiece optical system 7 is formed by means of a toric surface, the pupil aberrations, the astigmatism in particular, of the eyepiece can be eliminated to make it possible to observe a bright image to be observed by lowering the diffusion characteristic of the diffusion member 6. Furthermore, it is possible to reduce the brightness of the light source of illumination of the image display element 3 so that an image can be observed at a reduced electric power level.

Still preferably, a diffusion plate described in JP-A-2004-102204 filed by the applicant of the present invention is employed for the diffusion member 6.

Still preferably, two projection optical systems 4 that correspond to the left and right eyeballs (entrance pupils) E may be are arranged to project images of the two projection optical systems 4 onto the diffusion member 6. Then, at the same time, a stereoscopic image can be observed by controlling the diffusion angle of the diffusion member 6 so as not to give rise to any crosstalk of the two images.

Additionally, a holographic diffusion member 6 may be selected for the diffusion member 6 to avoid a problem that the diffusion member 6 itself becomes observable.

Furthermore, the above problem can be dissolved by rotating or oscillating the diffusion member 6. Still additionally, a so-called combiner for displaying an external image and an electronic image in a superposed manner can be realized by forming the eyepiece optical system 7 by means of a semi-transparent surface. If such is the case, it is preferably a combiner operating as a concave mirror formed by bonding a holographic element to an annular base plate.

FIG. 3 is a schematic illustration of an application where a visual display apparatus 1 according to the present invention and a seat S are combined. The seat S may be a sofa or a seat S of a vehicle and the visual display apparatus 1 is integrally connected to the seat S. Therefore, when the seat S is provided with a reclining mechanism, the visual display apparatus 1 has to change its angle according to the angle of the inclined back S1 of the seat S.

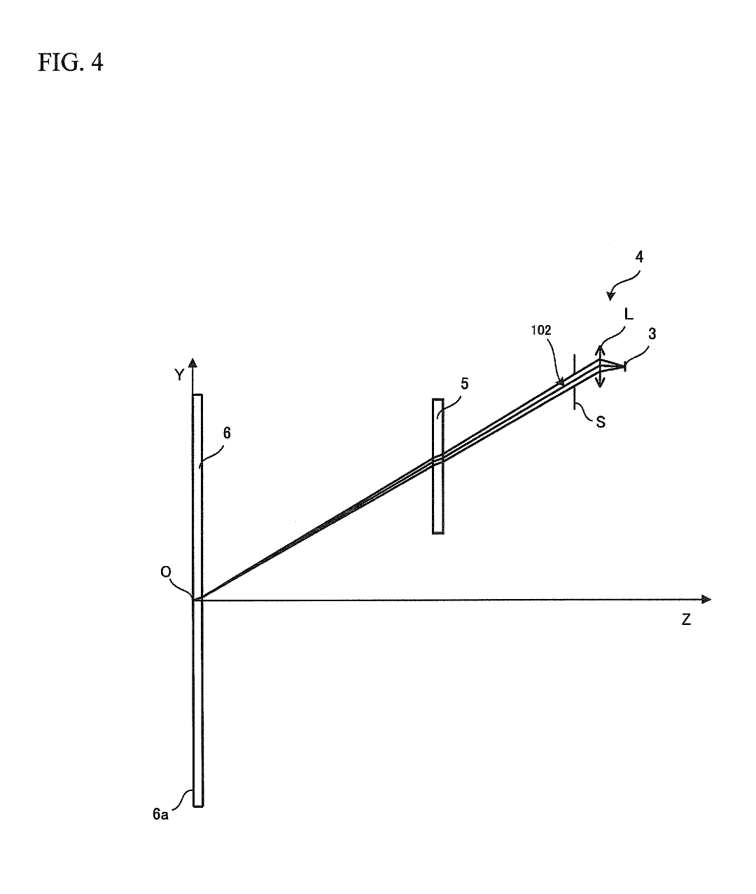

Now, examples of visual display apparatus 1 according to the present invention will be described below. The parameters of arrangement of the optical systems of these examples will be listed hereinafter. The parameters of arrangement of each of the examples are obtained by tracing back the rays of light directed to the image display element 3 from the diffusion member 6 and getting to the image display element 3 by way of the image distortion correcting element 5 as illustrated in FIG. 4.

The coordinate system of each of the examples has the origin O on the decentered optical surface of the decentered optical system at the intersection O of the first surface 6a of the diffusion member 6 and the central main ray of light 102 and the upward direction rising from the origin O and from the drawing is defined to be the positive direction of the Y-axis while the rightward direction from the origin O on the drawing is defined to be the positive direction of the Z-axis and the plane of FIG. 4 is defined to be the Y-Z plane. The X-axis for forming the right hand orthogonal coordinate system with the Y-axis and the Z-axis is defined to be in the positive direction of the X-axis.

As for the decentered surface, the quantities of decentralization (X, Y and Z respectively in the direction of the X-axis, in the direction of the Y-axis and in the direction of the Z-axis) from the origin of the above optical system of the coordinate system by which the surface is defined and the angles of inclination of the coordinate system (α, β and γ (°) respectively) by which the surfaces centered at the X-axis, Y-axis and Z-axis of the coordinate system are defined by means of the origin of the optical system are given. A positive value of α and that of β refer to counterclockwise rotations around the respective axes and a positive value of γ refers to a clockwise rotation relative to the positive direction. As for rotations by α, β and γ around the respective central axes, the coordinate system defining each surface is firstly rotated counterclockwise by a around the X-axis of the coordinate system defined by means of the origin of the optical system, then rotated counterclockwise by β around the Y-axis of the coordinate system obtained as a result of the first rotation and finally rotated clockwise by γ around the Z-axis of the coordinate system obtained as a result of the second rotation.

Additionally, if a specific surface and the succeeding surface of the optically acting surfaces of the optical system of each of the examples form a coaxial optical system the surface interval is given. Otherwise, the radius of curvature of each of the surfaces, the refractive index of the medium and the Abbe number are given according to the customary practice.

The shape of the free-form surface that is employed for the purpose of the present invention is defined by formula (a) represent below. Note that the Z-axis of the definition formula operates as the axis of the free-form surface.

$$Z = ( {r}^{2} / R ) / [ 1 + √ \{ 1 - ( 1 + k ) {( r / R )}^{2} \} ] + {\sum }_{j = 1}^{∞} {C}_{j} {X}^{m} {Y}^{n} , \qquad ( a )$$

where the first term is the spherical surface term and the second term is the free-form surface term.

The following definitions are applicable to the spherical surface term.

R: radius of curvature at the vertex

k: conic constant

r=√(X²+Y²)

The following definitions are applicable to the free-form surface term.

$${\sum }_{j = 1}^{66} {C}_{j} {X}^{m} {Y}^{n} = {C}_{1} + {C}_{2} X + {C}_{3} Y + {C}_{4} {Y}^{2} + {C}_{5} XY + {C}_{6} {Y}^{2} + {C}_{7} {Y}^{3} + {C}_{8} {X}^{2} Y + {C}_{9} {XY}^{2} + {C}_{10} {Y}^{3} + {C}_{11} {Y}^{4} + {C}_{12} {X}^{3} Y + {C}_{13} {X}^{2} {Y}^{2} + {C}_{14} {XY}^{3} + {C}_{15} {Y}^{4} + {C}_{16} {Y}^{5} + {C}_{17} {X}^{4} Y + {C}_{18} {X}^{3} {Y}^{2} + {C}_{19} {X}^{2} {Y}^{3} + {C}_{20} {XY}^{4} + {C}_{21} {Y}^{5} + {C}_{22} {Y}^{6} + {C}_{23} {X}^{5} Y + {C}_{24} {X}^{4} {Y}^{2} + {C}_{25} {X}^{3} {Y}^{3} + {C}_{26} {X}^{2} {Y}^{4} + {C}_{27} {XY}^{5} + {C}_{28} {Y}^{6} + {C}_{29} {Y}^{7} + {C}_{30} {X}^{6} Y + {C}_{31} {X}^{5} {Y}^{2} + {C}_{32} {X}^{4} {Y}^{3} + {C}_{33} {X}^{3} {Y}^{4} + {C}_{34} {X}^{2} {Y}^{5} + {C}_{35} {XY}^{6} + {C}_{36} {Y}^{7} . . . ,$$

where Cⱼ (j being an integer not less than 1) is a coefficient.

While a free-form surface generally does not have any surface of symmetry for both the X-Z surface and the Y-Z surface, a single surface of symmetry that is parallel to the Y-Z surface can be made to exist for the above free-form surface according to the present invention by making all the terms of odd-number-th degrees for X equal to 0. For example, in the above definition formula (a), such a surface of symmetry can be made to exist by making all the coefficients of the terms including C₂, C₅, C₇, C₉, C₁₂, C₁₄, C₁₆, C₁₈, C₂₀, C₂₃, C₂₅, C₂₇, C₂₉, C₃₁, C₃₃, C₃₅, . . . equal to 0.

Similarly, a single surface of symmetry that is parallel to the X-Z surface can be made to exist for the above free-form surface according to the present invention by making all the terms of odd-number-th degrees for Y equal to 0. For example, in the above definition formula, such a surface of symmetry can be made to exist by making all the coefficients of the terms including C₃, C₅, C₈, C₁₀, C₁₂, C₁₄, C₁₇, C₁₉, C₂₁, C₂₃, C₂₅, C₂₇, C₃₀, C₃₂, C₃₄, C₃₆, . . . equal to 0.

The preparation process for such a visual display apparatus can be improved while efficiently correcting the aberrations that are rotationally asymmetric and arise due to decentration by allowing a surface of symmetry to exist in either of the directions for surface of symmetry and selecting the direction of the Y-axis for the direction of decentration of the optical system if the surface of symmetry is in parallel with the Y-Z surface but the direction of the X-axis for the direction of decentration of the optical system if the surface of symmetry is in parallel with the X-Z surface.

Note that the above definition formula (a) is represented as an example as described above. A visual display apparatus according to the present invention is characterized in that the aberrations that are rotationally asymmetric and arise due to decentration are corrected and the preparation process is improved at the same time by using a rotationally asymmetric surface having a single surface of symmetry and hence the same effect can be achieved by using some other definition formula.

Also note that all the terms relating to any non-spherical surface for which no data is described in the parameters of arrangement that will be described hereinafter are equal to 0. The refractive indexes and the Abbe numbers that correspond to the d line (wavelength: 587.56 nm) are listed. The unit of length is mm. The decentration of each surface is expressed by the quantity of decentration from a reference surface as described above.

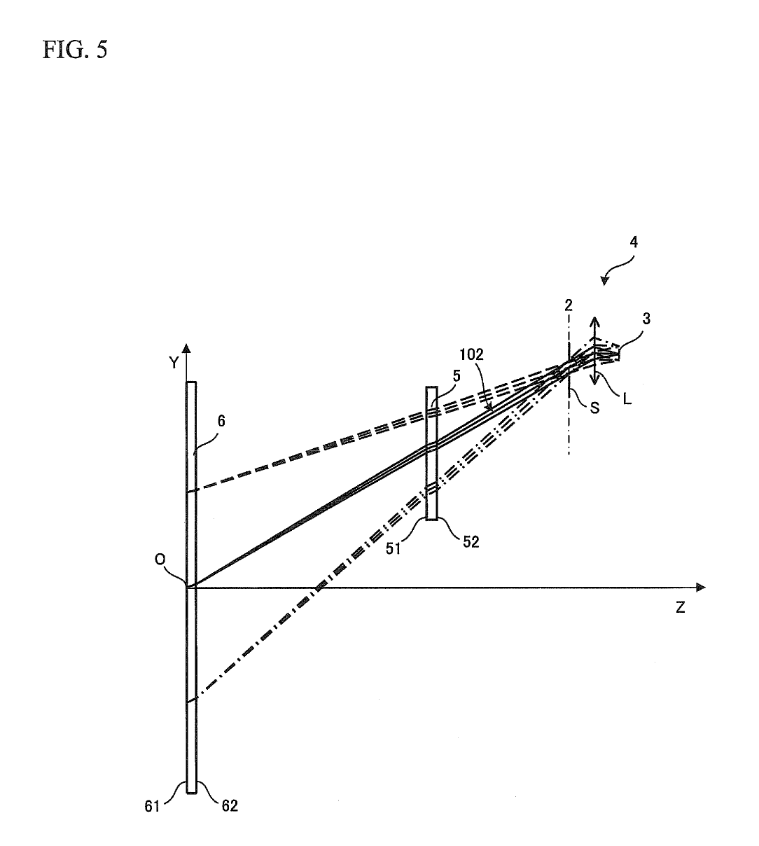

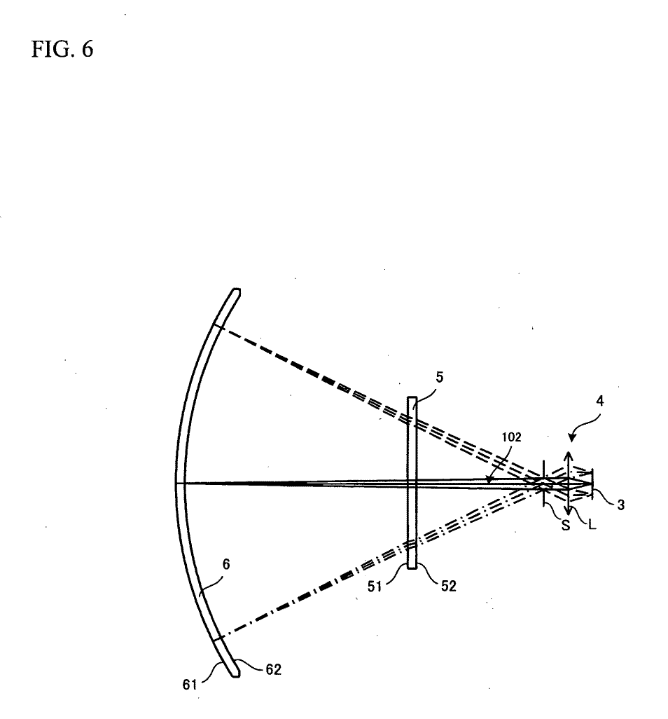

FIG. 5 is a schematic cross-sectional view of the visual display apparatus 1 of Example 1 taken along the axis of rotational symmetry 2 thereof. FIG. 6 is a schematic plan view corresponding to FIG. 5. Note that the eyepiece optical system 7 is not illustrated in FIGS. 5 and 6.

The visual display apparatus 1 of Example 1 includes an image display element 3, a projection optical system 4 for projecting the image displayed on the image display element 3, a diffusion member 6 arranged near the image projected by the projection optical system 4 and an eyepiece optical system 7 (not illustrated) having positive reflection power for a remote virtual image that is the image projected by the projection optical system 4. The image projected by the eyepiece optical system 7, the diffusion member 6 and the projection optical system 4 is arranged so as to draw a circular arc at an arbitrary position in a plane orthogonal relative to the common axis of rotational symmetry 2. The image distortion correcting element 5 of this example corrects the bow-like image distortion of the virtual image to be observed by the eyepiece optical system 7.

The diffusion member 6 has the first surface 61 that is formed by a cylindrical surface and the second surface 62 that is also formed by a cylindrical surface. The image projected by the projection optical system 4 is projected in the form of a cylinder or a cone near the diffusion member 6.

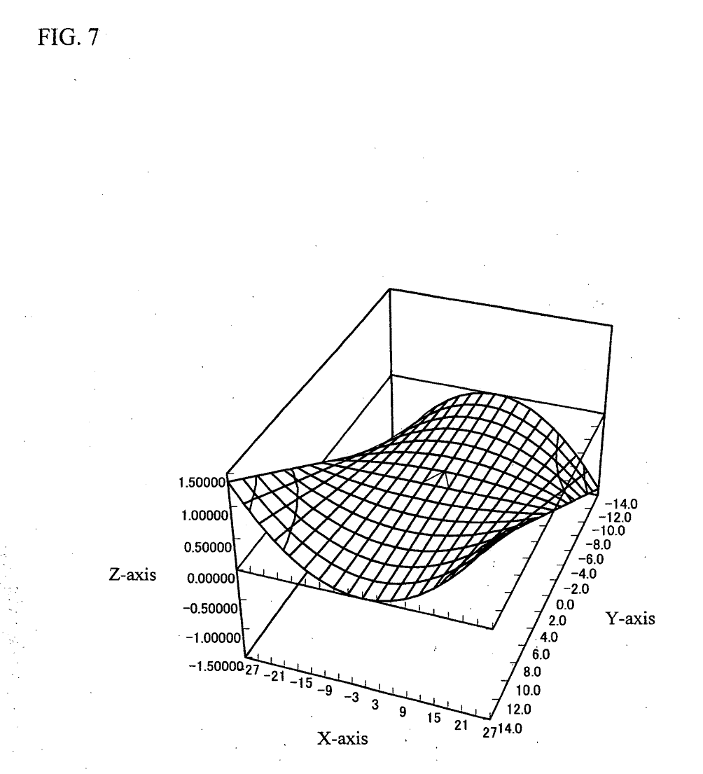

As illustrated in FIG. 7, the image distortion correcting element 5 has the first surface 51 that is formed by a free-form surface and the second surface 52 that is formed by a plane surface.

The projection optical system 4 has an ideal lens L and an image display element 3.

An aperture (or stop?) S is arranged between the projection optical system 4 and the image distortion correcting element 5.

In reverse ray trace, a flux of light passes from the first surface 61 of the diffusion member 6 where an intermediate image is formed through the second surface 62 to exit the diffusion member 6. The flux of light exiting the diffusion member 6 then enters the image distortion correcting element 5. The flux of light that enters from the first surface 51 of the image distortion correcting element 5 and exits from the second surface 52 then enters the projection optical system 4 by way of the aperture S. The flux of light that enters the projection optical system 4 passes through the ideal lens L and forms an image on the image display element 3.

The specifications of this Example 1 include the following.

Angle of View:

| | |
|---|---|
| vertical | 30° |
| horizontal | 60° |

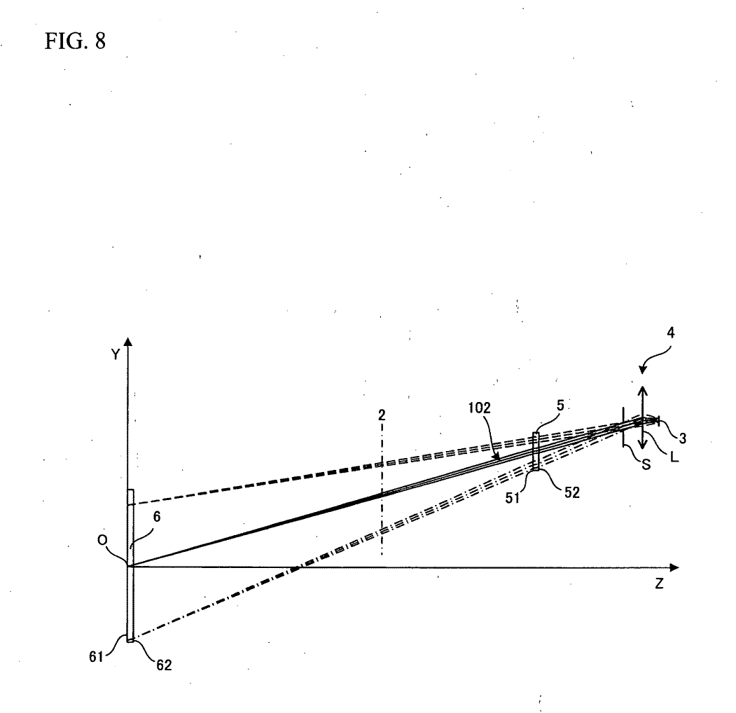

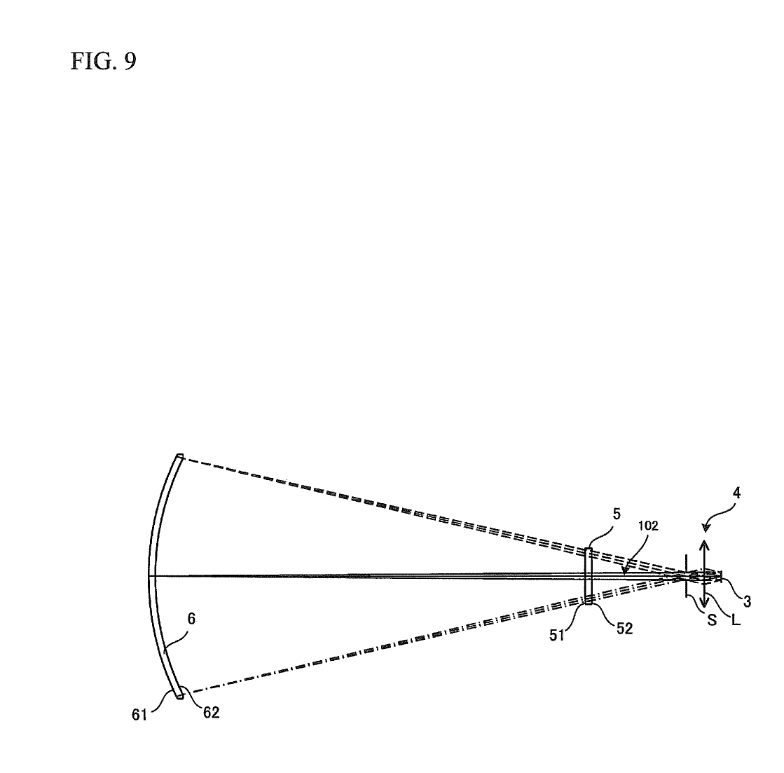

FIG. 8 is a schematic cross-sectional view of the visual display apparatus 1 of Example 2 taken along the axis of rotational symmetry 2 thereof. FIG. 9 is a schematic plan view corresponding to FIG. 8. Note that the eyepiece optical system 7 is not illustrated in FIGS. 8 and 9.

The visual display apparatus 1 of Example 2 includes an image display element 3, a projection optical system 4 for projecting the image displayed on the image display element 3, a diffusion member 6 arranged near the image projected by the projection optical system 4 and an eyepiece optical system 7 (not illustrated) having positive reflection power for a remote virtual image that is the image projected by the projection optical system 4. The image projected by the eyepiece optical system 7, the diffusion member 6 and the projection optical system 4 is arranged so as to draw a circular arc at an arbitrary position in a plane orthogonal relative to the common axis of rotational symmetry 2. The image distortion correcting element 5 of this example corrects the bow-like image distortion of the virtual image to be observed by the eyepiece optical system 7.

The diffusion member 6 has the first surface 61 that is formed by a cylindrical surface and the second surface 62 that is also formed by a cylindrical surface. The image projected by the projection optical system 4 is projected in the form of a cylinder or a cone near the diffusion member 6.

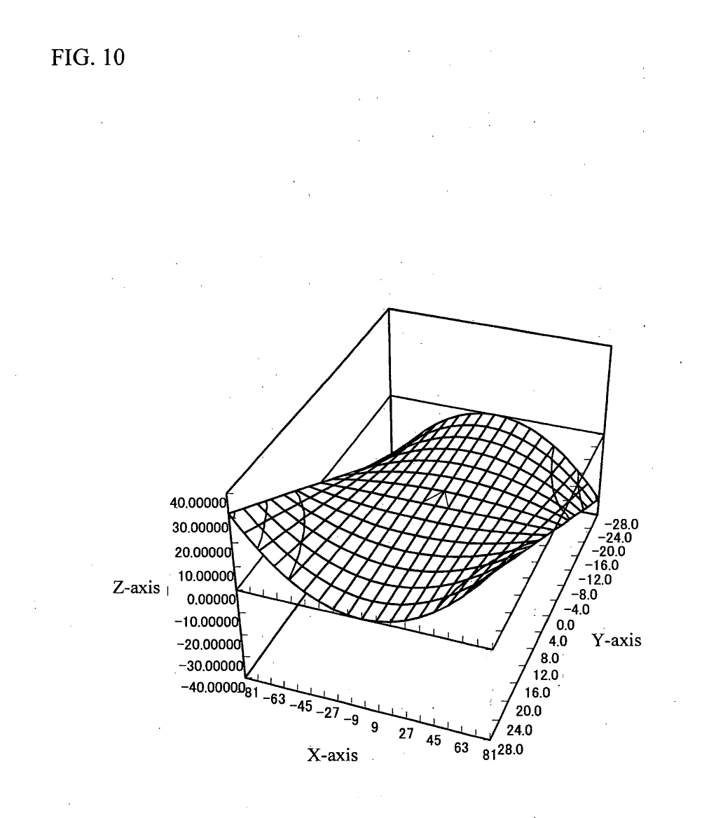

As illustrated in FIG. 10, the image distortion correcting element 5 has the first surface 51 that is formed by a free-form surface and the second surface 52 that is formed by a free-form surface. The second free-form surface is formed by a plane surface in this example from the design point of view.

The projection optical system 4 has an ideal lens L and an image display element 3.

An aperture S is arranged between the projection optical system 4 and the image distortion correcting element 5.

In reverse ray trace, a flux of light passes from the first surface 61 of the diffusion member 6 where an intermediate image is formed through the second surface 62 to exit the diffusion member 6. The flux of light exiting the diffusion member 6 then enters the image distortion correcting element 5. The flux of light that enters from the first surface 51 of the image distortion correcting element 5 and exits from the second surface 52 then enters the projection optical system 4 by way of the aperture S. The flux of light that enters the projection optical system 4 passes through the ideal lens L and forms an image on the image display element 3.

The specifications of this Example 2 include the following.

Angle of View

| | |
|---|---|
| vertical | 30° |
| horizontal | 60° |

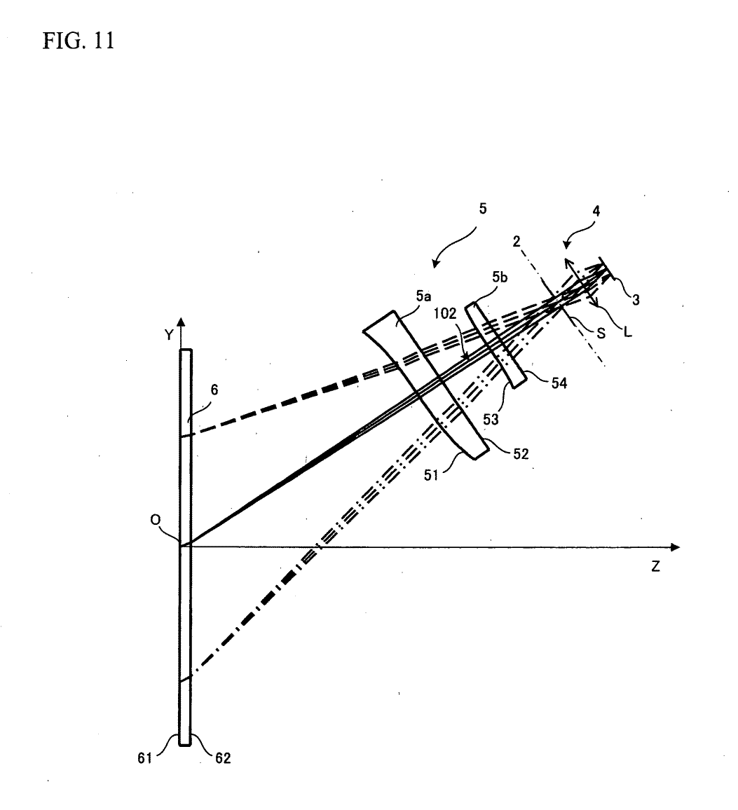

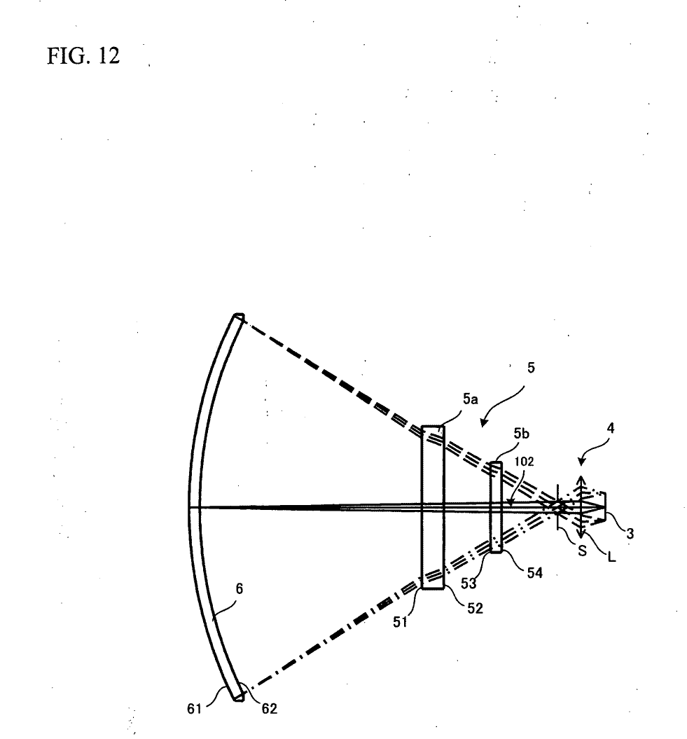

FIG. 11 is a schematic cross-sectional view of the visual display apparatus 1 of Example 3 taken along the axis of rotational symmetry 2 thereof. FIG. 12 is a schematic plan view corresponding to FIG. 11. Note that the eyepiece optical system 7 is not illustrated in FIGS. 11 and 12.

The visual display apparatus 1 of Example 3 includes an image display element 3, a projection optical system 4 for projecting the image displayed on the image display element 3, a diffusion member 6 arranged near the image projected by the projection optical system 4 and an eyepiece optical system 7 (not illustrated) having positive reflection power for a remote virtual image that is the image projected by the projection optical system 4. The image projected by the eyepiece optical system 7, the diffusion member 6 and the projection optical system 4 is arranged so as to draw a circular arc at an arbitrary position in a plane orthogonal relative to the common axis of rotational symmetry 2. The image distortion correcting element 5 of this example corrects the bow-like image distortion of the virtual image to be observed by the eyepiece optical system 7.

The diffusion member 6 has the first surface 61 that is formed by a cylindrical surface and the second surface 62 that is also formed by a cylindrical surface. The image projected by the projection optical system 4 is projected in the form of a cylinder or a cone near the diffusion member 6.

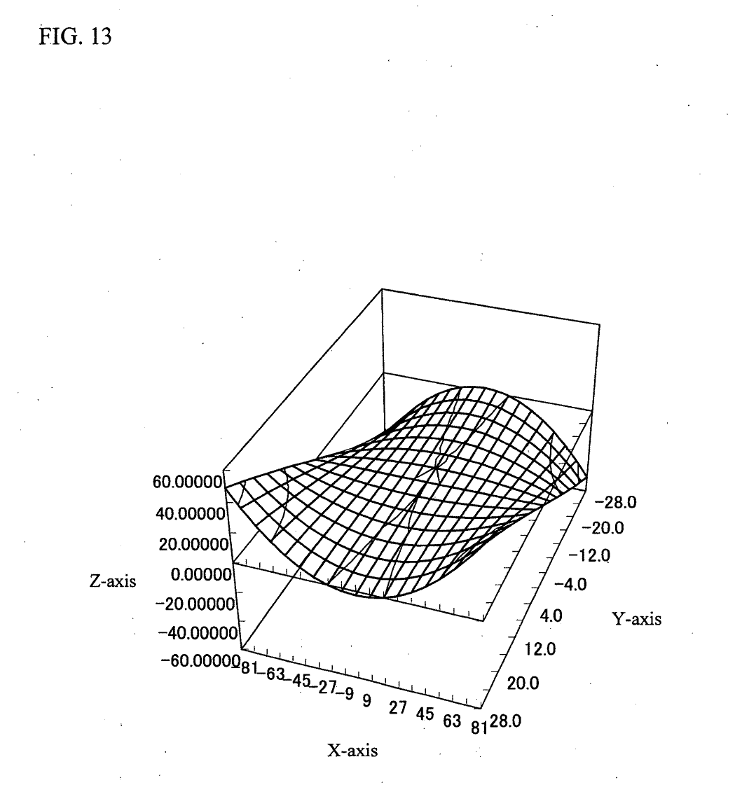

The image distortion correcting element 5 has the first image distortion correcting element 5a and the second image distortion correcting element 5b. The first image distortion correcting element 5a by turn has the first surface 51 that is formed by a free-form surface and the second surface 52 that is formed by a plane surface as illustrated in FIG. 13. Although not illustrated, the second image distortion correcting element 5b has the third surface 53 that is formed by free-form surface and the fourth surface 54 that is formed by a plane surface. The free-form surface of the second surface 52 and that of the fourth surface 54 are formed by respective plane surfaces in this example from the design point of view.

The projection optical system 4 has an ideal lens L and an image display element 3.

An aperture S is arranged between the projection optical system 4 and the image distortion correcting element 5.

Note that the second surface 62 of the diffusion member 6 has a virtual surface at a decentered position on the coordinate system.

In reverse ray trace, a flux of light passes from the first surface 61 of the diffusion member 6 where an intermediate image is formed through the second surface 62 to exit the diffusion member 6. The flux of light exiting the diffusion member 6 then enters the image distortion correcting element 5. The flux of light that enters from the first surface 51 of the first image distortion correcting element 5a of the image distortion correcting element 5 and exits from the second surface 52. Then, it enters from the third surface 53 of the second image distortion correcting element 5b and exits from the fourth surface 54. The flux of light exiting the image distortion correcting element 5 then enters the projection optical system 4 by way of the aperture S. The flux of light that enters the projection optical system 4 passes through the ideal lens L and forms an image on the image display element 3.

The specifications of this Example 3 include the following.

Angle of View:

| | |
|---|---|
| vertical | 30° |
| horizontal | 60° |

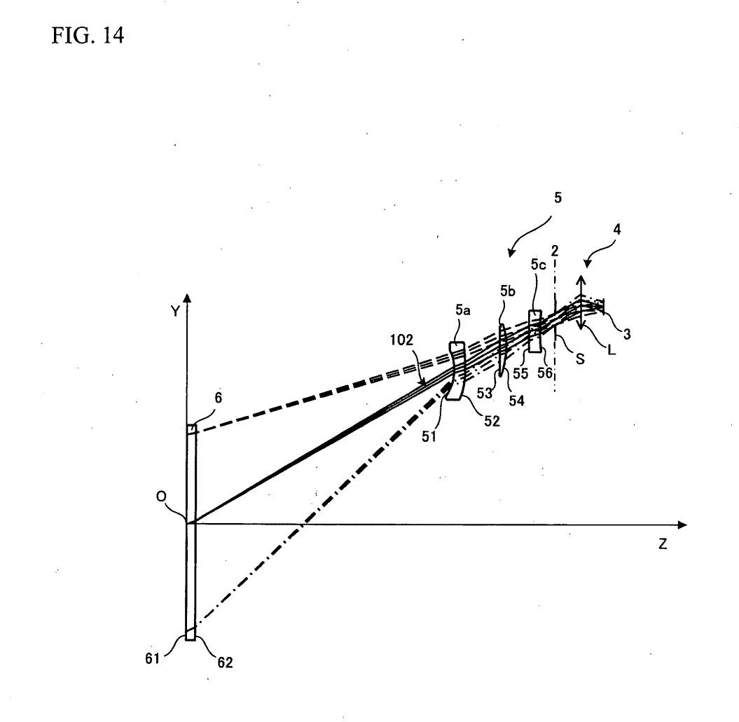

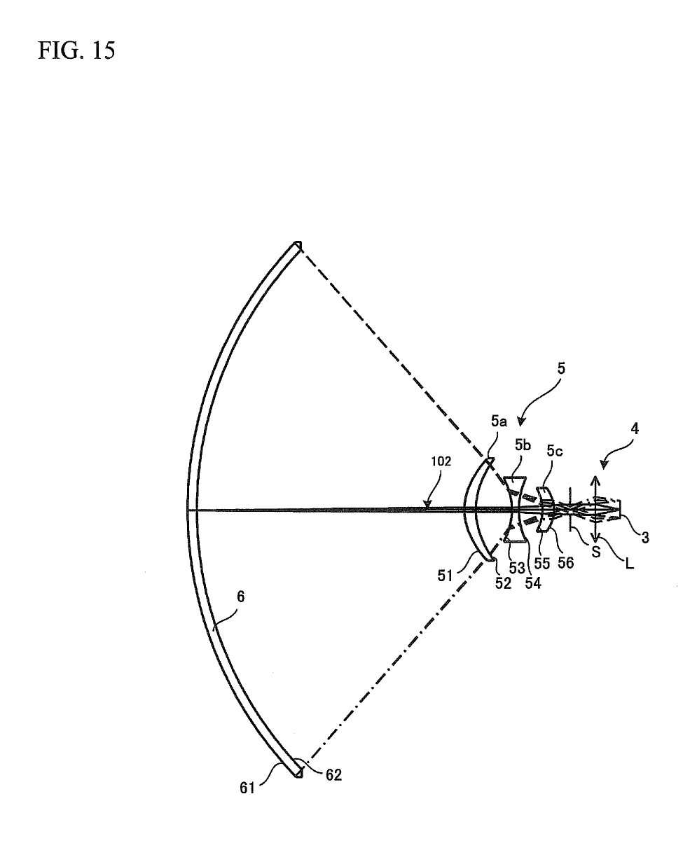

FIG. 14 is a schematic cross-sectional view of the visual display apparatus 1 of Example 4 taken along the axis of rotational symmetry 2 thereof. FIG. 15 is a schematic plan view corresponding to FIG. 14. Note that the eyepiece optical system 7 is not illustrated in FIGS. 14 and 15.

The visual display apparatus 1 of Example 4 includes an image display element 3, a projection optical system 4 for projecting the image displayed on the image display element 3, a diffusion member 6 arranged near the image projected by the projection optical system 4 and an eyepiece optical system 7 (not illustrated) having positive reflection power for a remote virtual image that is the image projected by the projection optical system 4. The image projected by the eyepiece optical system 7, the diffusion member 6 and the projection optical system 4 is arranged so as to draw a circular arc at an arbitrary position in a plane orthogonal relative to the common axis of rotational symmetry 2. The image distortion correcting element 5 of this example corrects the bow-like image distortion of the virtual image to be observed by the eyepiece optical system 7.

The diffusion member 6 has the first surface 61 that is formed by a cylindrical surface and the second surface 62 that is also formed by a cylindrical surface. The image projected by the projection optical system 4 is projected in the form of a cylinder or a cone near the diffusion member 6.

The image distortion correcting element 5 has the first image distortion correcting element 5a, the second image distortion correcting element 5b and the third image distortion correcting element 5c. The first image distortion correcting element 5a by turn has the first surface 51 that is formed by a free-form surface and the second surface 52 that is formed also by a free-form surface. The second image distortion correcting element 5b has the third surface 53 that is formed by free-form surface and the fourth surface 54 that is formed also by a free-form surface. The third image distortion correcting element 5c has the fifth surface 55 that is formed by a free-form surface and the sixth surface 56 that is formed also by a free-form surface.

The projection optical system 4 has an ideal lens L and an image display element 3.

An aperture S is arranged between the projection optical system 4 and the image distortion correcting element 5.

In reverse ray trace, a flux of light passes from the first surface 61 of the diffusion member 6 where an intermediate image is formed through the second surface 62 to exit the diffusion member 6. The flux of light exiting the diffusion member 6 then enters the image distortion correcting element 5. The flux of light enters from the first surface 51 of the first image distortion correcting element 5a of the image distortion correcting element 5 and exits from the second surface 52. Then, it enters from the third surface 53 of the second image distortion correcting element 5b and exits from the fourth surface 54. Subsequently, it enters from the fifth surface 55 of the third image distortion correcting element 5 and exits from the sixth surface 5. The flux of light exiting the image distortion correcting element 5 then enters the projection optical system 4 by way of the aperture S. The flux of light that enters the projection optical system 4 passes through the ideal lens L and forms an image on the image display element 3.

The specifications of this Example 4 include the following.

Angle of View:

| | |
|---|---|
| vertical | 30° |
| horizontal | 60° |

The parameters of arrangement of Examples 1 through 4 are listed below. In the table below, “FFS” refers to free-form surface. The data relating to the eyepiece optical systems 7 are now illustrated.

### Example 1

| Surface | Radius | Plane | | Refractive | Abbe |
|---|---|---|---|---|---|
| number | of curvature | gap | Eccentricity | index | number |
| Object | cylindrical [1] | 4.00 | 1.5163 | 64.1 | |
| 1 | cylindrical [2] | 100.00 | | | |
| 2 | FFS [1] | 4.00 | eccentricity (1) | 1.5163 | 64.1 |
| 3 | ∞ | 57.00 | eccentricity (1) | | |
| 4 | ∞ (stop) | 11.00 | eccentricity (2) | | |
| 5 | ideal lens | 11.02 | | | |
| Image | ∞ | | eccentricity (3) | | |

cylindrical [1]

| | | | |
|---|---|---|---|
| Curvature radius of | 165.00 | Curvature radius of Y direction | ∞ |
| X direction | | | |

cylindrical [2]

| | | | |
|---|---|---|---|
| Curvature radius of | 161.00 | Curvature radius of Y direction | ∞ |
| X direction | | | |

FFS[1]

| | |
|---|---|
| C8 | 1.3501E−004 |

eccentricity [1]

| | | | | | |
|---|---|---|---|---|---|
| X | 0.00 | Y | 59.49 | Z | 0.00 |
| α | 0.00 | β | 0.00 | γ | 0.00 |

eccentricity [2]

| | | | | | |
|---|---|---|---|---|---|
| X | 0.00 | Y | 94.00 | Z | 0.00 |
| α | 0.00 | β | 0.00 | γ | 0.00 |

eccentricity [3]

| | | | | | |
|---|---|---|---|---|---|
| X | 0.00 | Y | 99.90 | Z | 0.00 |
| α | 0.00 | β | 0.00 | γ | 0.00 |

### Example 2

| Surface | Radius | Plane | | Refractive | Abbe |
|---|---|---|---|---|---|
| number | of curvature | gap | Eccentricity | index | number |
| Object | cylindrical [1] | 4.00 | | 1.5163 | 64.1 |
| 1 | cylindrical [2] | 261.00 | | | |
| 2 | FFS [1] | 4.00 | eccentricity (1) | 1.5163 | 64.1 |
| 3 | ∞ | 57.00 | eccentricity (1) | | |
| 4 | ∞ (stop) | 11.00 | eccentricity (2) | | |
| 5 | ideal lens | 10.35 | | | |
| Image | ∞ | 0.00 | eccentricity (3) | | |

cylindrical [1]

| | | | |
|---|---|---|---|
| Curvature radius of | 165.00 | Curvature radius of Y direction | ∞ |
| X direction | | | |

cylindrical [2]

| | | | |
|---|---|---|---|
| Curvature radius of | 161.00 | Curvature radius of Y direction | ∞ |
| X direction | | | |

FFS[1]

| | |
|---|---|
| C8 | 1.7396E−004 |

eccentricity [1]

| | | | | | |
|---|---|---|---|---|---|
| X | 0.00 | Y | 76.67 | Z | 0.00 |
| α | 0.00 | β | 0.00 | γ | 0.00 |

eccentricity [2]

| | | | | | |
|---|---|---|---|---|---|
| X | 0.00 | Y | 94.00 | Z | 0.00 |
| α | 0.00 | β | 0.00 | γ | 0.00 |

eccentricity [3]

| | | | | | |
|---|---|---|---|---|---|
| X | 0.00 | Y | 96.91 | Z | 0.00 |
| α | 0.00 | β | 0.00 | γ | 0.00 |

### Example 3

| Surface | Radius | Plane | | Refractive | Abbe |
|---|---|---|---|---|---|
| number | of curvature | gap | Eccentricity | index | number |
| Object | cylindrical [1] | 4.00 | | 1.5163 | 64.1 |
| 1 | cylindrical [2] | 0.00 | | | |
| 2 | ∞ (virtual) | 100.00 | eccentricity (1) | | |
| 3 | FFS [1] | 10.00 | | 1.5163 | 64.1 |
| 4 | ∞ | 21.00 | | | |
| 5 | FFS [2] | 5.00 | | 1.5163 | 64.1 |
| 6 | ∞ | 25.00 | | | |
| 7 | ∞ (stop) | 11.00 | | | |
| 8 | ideal lens | 10.70 | | | |
| Image | ∞ | 0.00 | | | |

cylindrical [1]

| | | | |
|---|---|---|---|
| Curvature radius of | 165.00 | Curvature radius of Y direction | ∞ |
| X direction | | | |

cylindrical [2]

| | | | |
|---|---|---|---|
| Curvature radius of | 161.00 | Curvature radius of Y direction | ∞ |
| X direction | | | |

FFS [1]

| | | | |
|---|---|---|---|
| C8 | 2.8126E−004 | C10 | −1.2005E−004 |

FFS [2]

| | | | |
|---|---|---|---|
| C8 | −1.7836E−004 | C10 | 1.8721E−004 |

eccentricity [1]

| | | | | | |
|---|---|---|---|---|---|
| X | 0.00 | Y | 0.00 | Z | 0.00 |
| α | 34.20 | β | 0.00 | γ | 0.00 |

### Example 4

| Surface | Radius | Plane | | Refractive | Abbe |
|---|---|---|---|---|---|
| number | of curvature | gap | Eccentricity | index | number |
| Object | cylindrical [1] | 4.00 | | 1.5163 | 64.1 |
| 1 | cylindrical [2] | 116.00 | | | |
| 2 | FFS [1] | 5.00 | eccentricity (1) | 1.4875 | 70.4 |
| 3 | FFS [2] | 15.62 | eccentricity (1) | | |
| 4 | FFS [3] | 3.00 | eccentricity (2) | 1.5883 | 62.1 |
| 5 | FFS [4] | 10.29 | eccentricity (2) | | |
| 6 | FFS [5] | 5.00 | eccentricity (3) | 1.7526 | 27.7 |
| 7 | FFS [6] | 7.00 | eccentricity (3) | | |
| 8 | ∞ (stop) | 11.00 | eccentricity (4) | | |
| 9 | ideal lens | 10.82 | | | |
| Image | ∞ | 0.00 | eccentricity (5) | | |

cylindrical [1]

| | | | |
|---|---|---|---|
| Curvature radius of | 165.00 | Curvature radius of Y direction | ∞ |
| X direction | | | |

cylindrical [2]

| | | | |
|---|---|---|---|
| Curvature radius of | 161.00 | Curvature radius of Y direction | ∞ |
| X direction | | | |

FFS [1]

| | | | | | |
|---|---|---|---|---|---|
| C4 | 2.0282E−002 | C6 | −2.5421E−002 | C8 | 6.1191E−004 |
| C10 | 2.8544E−006 | | | | |

FFS [2]

| | | | | | |
|---|---|---|---|---|---|
| C4 | 1.6310E−002 | C6 | −8.3290E−003 | C8 | 1.9491E−004 |
| C10 | 4.2973E−004 | | | | |

FFS [3]

| | | | | | |
|---|---|---|---|---|---|
| C4 | −1.8690E−002 | C6 | −3.1837E−004 | C8 | 9.2985E−006 |
| C10 | 1.5233E−006 | | | | |

FFS [4]

| | | | | | |
|---|---|---|---|---|---|
| C4 | 1.6063E−002 | C6 | −1.5116E−002 | C8 | 9.0846E−004 |
| C10 | −1.8434E−004 | | | | |

FFS [5]

| | | | | | |
|---|---|---|---|---|---|
| C4 | −2.9734E−002 | C6 | 7.0777E−004 | C8 | 1.9141E−003 |
| C10 | −5.9706E−006 | | | | |

FFS [6]

| | | | | | |
|---|---|---|---|---|---|
| C4 | −3.6449E−002 | C6 | 6.1773E−003 | C8 | 1.2721E−003 |
| C10 | −3.8750E−005 | | | | |

eccentricity [1]

| | | | | | |
|---|---|---|---|---|---|
| X | 0.00 | Y | 71.06 | Z | 0.00 |
| α | 0.00 | β | 0.00 | γ | 0.00 |

eccentricity [2]

| | | | | | |
|---|---|---|---|---|---|
| X | 0.00 | Y | 81.94 | Z | 0.00 |
| α | 0.00 | β | 0.00 | γ | 0.00 |

eccentricity [3]

| | | | | | |
|---|---|---|---|---|---|
| X | 0.00 | Y | 88.59 | Z | 0.00 |
| α | 0.00 | β | 0.00 | γ | 0.00 |

eccentricity [4]

| | | | | | |
|---|---|---|---|---|---|
| X | 0.00 | Y | 94.00 | Z | 0.00 |
| α | 0.00 | β | 0.00 | γ | 0.00 |

eccentricity [5]

| | | | | | |
|---|---|---|---|---|---|
| X | 0.00 | Y | 99.78 | Z | 0.00 |
| α | 0.00 | β | 0.00 | γ | 0.00 |

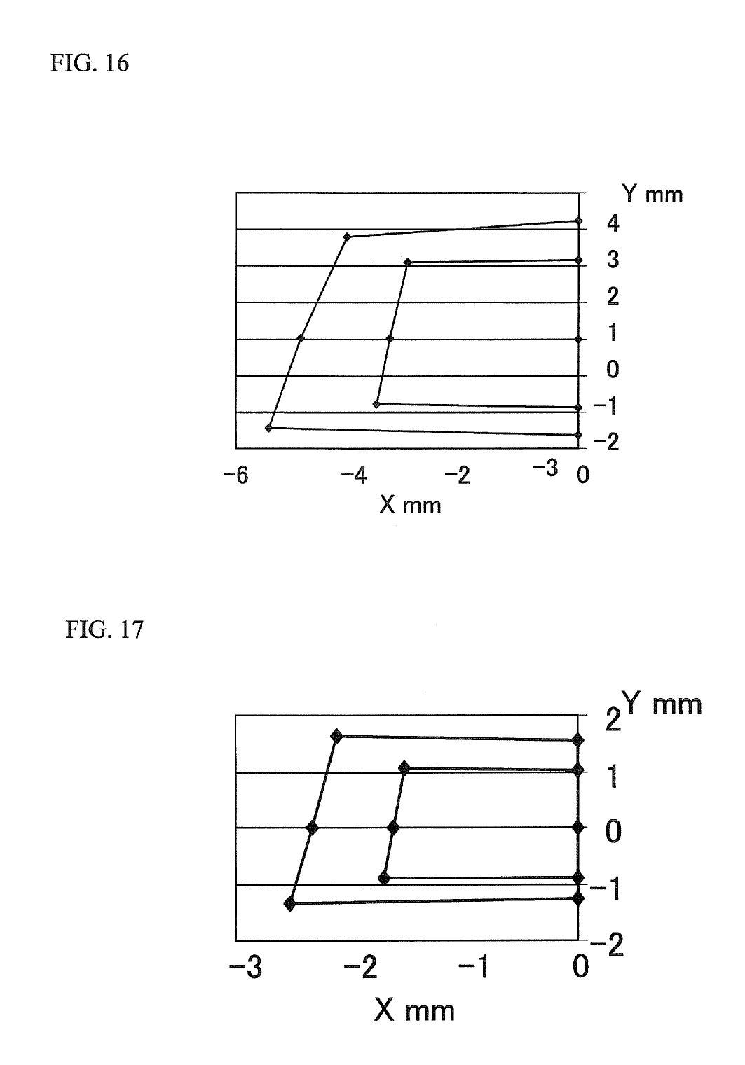

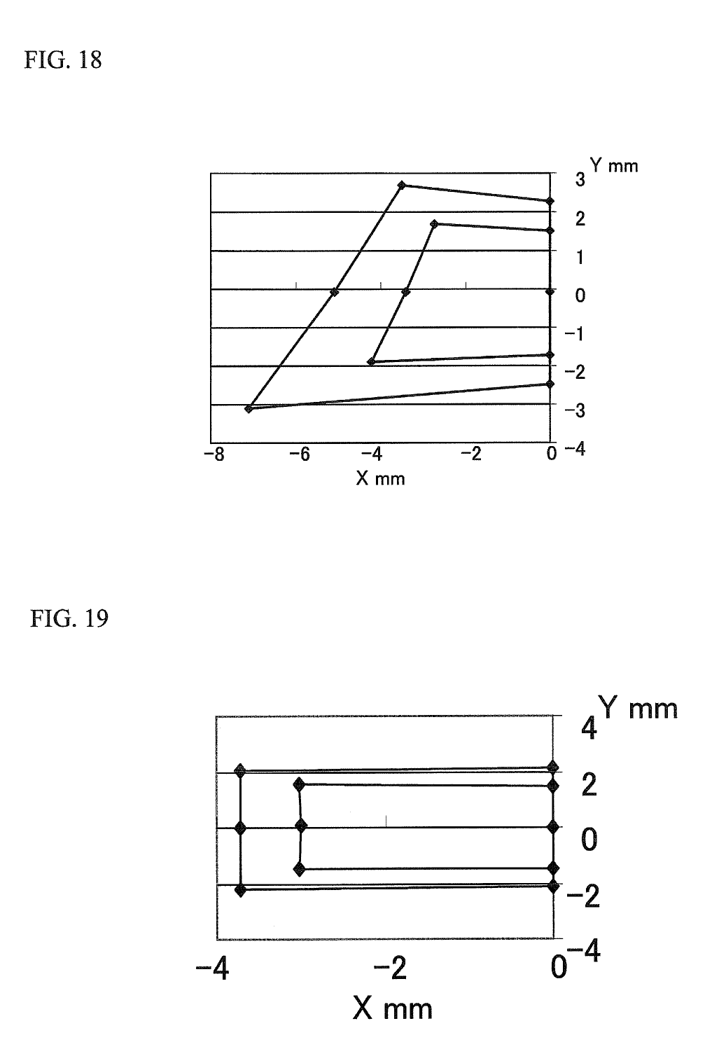

FIGS. 16 through 19 schematically illustrate the respective image distortions of Examples 1 through 4. In each of these figures, the outer quasi-quadrilateral represents the distortion of the image plane with the greatest image height while the inner quasi-quadrilateral represents the distortion of the image plane with the greatest image height×0.7. When compared them with the image distortion of FIG. 20, it will be seen that the top side and the bottom side of the quasi-quadrilateral are close to horizontal lines and hence the bow-like image distortion is corrected.

Note that the correcting optical system 5 mainly corrects the bow-like image distortion in each of the Examples 1 through 3 but expands the angle of view particularly in the transversal direction and corrects both the bow-like image distortion and the trapezoidal image distortion. The projection optical system 4 is designed as ideal lens L.

The diffusion by the diffusion member 6 is omitted in the ray trace.

While the data on the spacing of the two eyes of the observer are omitted, the ray is traced on an assumption that the spacing is 50 mm in the optical path diagram along a horizontal cross section.

As for ray trace, rays are traced by reverse ray trace directed from the eyeballs of the observers to the exit pupil of the projection optical system.

Now, an embodiment of projection optical system 4 that uses actual lenses will be described below.

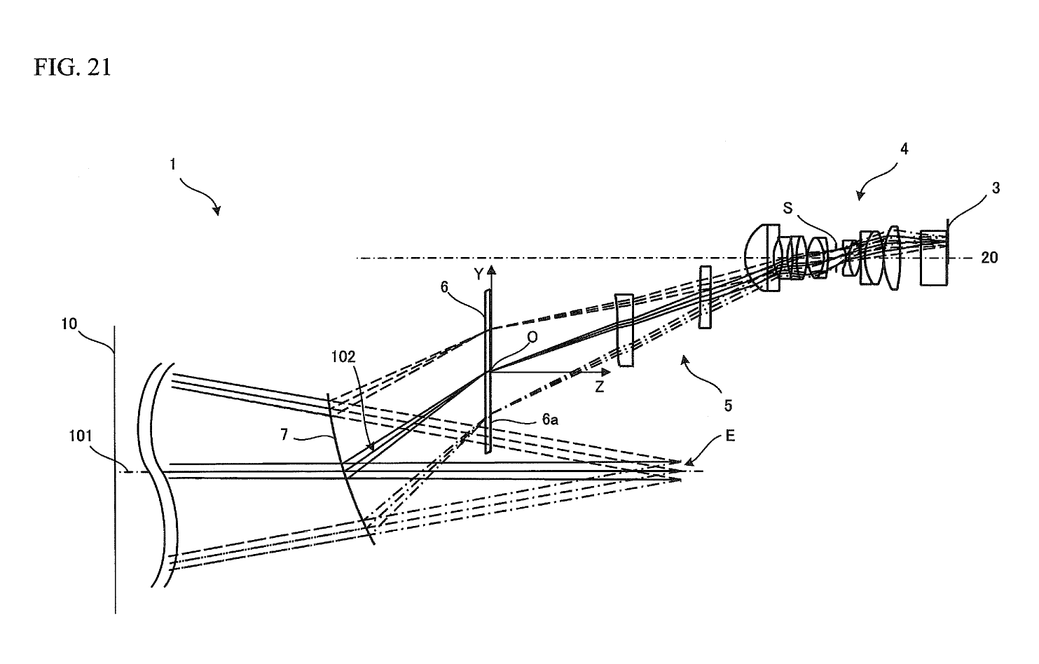

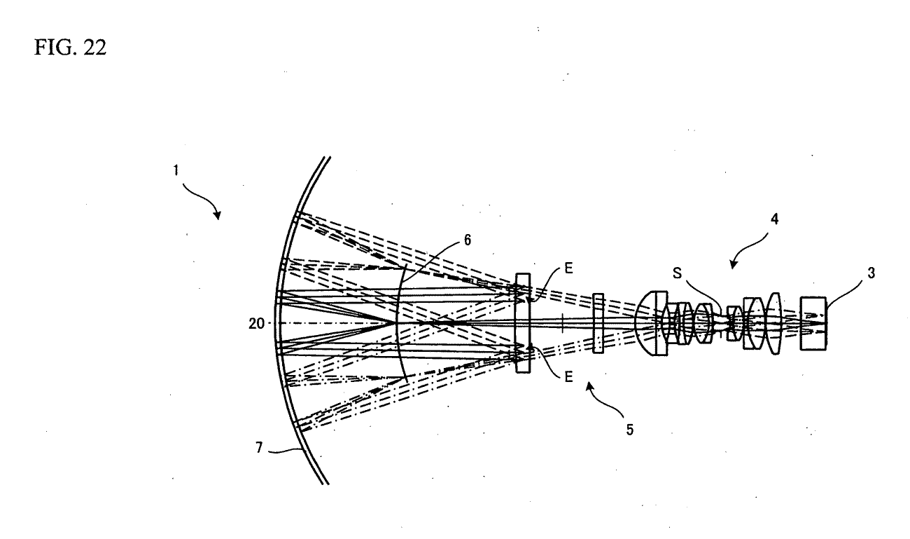

FIG. 21 is a schematic cross-sectional view of a visual display apparatus 1 using a projection optical system 4 formed by using actual lenses and FIG. 22 is a schematic plan view corresponding to FIG. 21.

In the projection optical system 4 of this embodiment for projecting the image being displayed on the image display element 3, the display surface of the image display element 3 and the projection surface of the projection optical system are decentered in the Y-Z cross section and the projection surface is formed by a curved surface of a circular arc with the chord thereof facing the side of the projection optical system 4 in the X-Z cross section and has the image distortion correcting element 5 as at least a rotationally asymmetric corrective optical surface for correcting the distortion of the image on the projection surface.

The visual display apparatus 1 of this embodiment can reduce the F number of the projection optical system 4 by expanding the diameter of the flux of light by means of the diffusion member 6. The eyepiece optical system 7 is characterized by forming a reflection surface and a diffusion surface that are rotationally symmetric relative to an axis of rotational symmetry and a projection image near the diffusion surface. For this purpose, it is important to form a rotationally symmetric projection surface by means of the projection optical system 4.

Since the projection image is projected from an oblique position decentered toward the curved diffusion member 6 (projection surface) in this embodiment, there arises a problem of producing a bow-like image distortion. Therefore, it is important to use at least a corrective surface for correcting the distortion.

Additionally, the display surface and the projection surface are shifted and decentered in parallel in the Y-Z cross section and the image distortion correcting element 5 corrects the bow-like image distortion that arises because the projection surface to which the flux of light is projected obliquely in the Y-Z cross section is cylindrical.

When the object surface and the image surface are parallel to each other and the projection optical system 4 does not give rise to any image distortion, theoretically no image distortion arises when the object surface and the image surface are shifted and decentered in parallel relative to each other. Thus, this embodiment is only required to correct the bow-like image distortion that arises because the projection surface is cylindrical. In other words, at least a single corrective surface is required for this embodiment. Additionally, such a bow-like image distortion needs to be corrected typically by a free-form surface that is rotationally asymmetric.

The angle of the corrective optical surface that the image distortion correcting element 5 has changes symmetrically relative to the Y-Z cross section as it is moved away from the Y-Z cross section in the positive direction and the negative direction of the X-axis.

To correct the bow-like image distortion, the surface profile needs to be such that the inclination of the surface changes as it is moved away from the central main ray of light in the positive direction and the negative direction of the X-axis (horizontal direction). Additionally, it is important that the inclination of the surface changes in the same direction regardless of positiveness or negativeness of the X-axis.

The corrective optical surface that the image distortion correcting element 5 has directs the ray of light to the side opposite to the central axis 20 of the projection optical system 4 as it is moved away from the Y-Z cross section in the positive direction and the negative direction of the X-axis and corrects the bow-like image distortion that arises with the chord thereof facing the side of the central axis 20 of the projection optical system 4 and the circular arc thereof facing the side opposite to the central axis 20 in the X-Y cross section.

Thus, it is possible to correct such a bow-like image distortion by making the profile of the corrective optical surface have an effect of directing the ray of light to the side opposite to the central axis 20 (downside) of the projection optical system 4 as it is moved away in the positive direction and the negative direction of the X-axis by referring to the Y-Z cross section. For example, while the image distortion correcting element 5 has parallel planes in the Y-Z cross section, the image distortion can be corrected by making it represent a trapezoidal wedge-like profile with its longer side directed downward as it is moved in the positive direction and the negative direction of the X-axis.

The corrective optical surface that the image distortion correcting element 5 has gives a C8 term (x²y term) when it is formed by means of a free-form surface defined by formula (a) represented below:

$$Z = ( {r}^{2} / R ) / [ 1 + √ \{ 1 - ( 1 + k ) {( r / R )}^{2} \} ] + {\sum }_{j = 1}^{∞} {C}_{j} {X}^{m} {Y}^{n} , \qquad ( a )$$

where R: radius of curvature at the vertex,

k: conic constant and

r=√(X+Y).

A free-form surface can correct the image distortion by giving an appropriate C8 term.

The display surface and the projection surface are tilted and decentered so as to form an angle in the Y-Z cross section and the image distortion correcting element 5 has at least two rotationally asymmetric surfaces as the corrective optical surfaces for correcting the image distortion.

A trapezoidal image distortion arises in the case of decentration where the object surface and the image surface form an angle (tilt and decentration), although the projection optical system 4 does not require a wide image field. The image distortion correcting element 5 is required to have at least two rotationally asymmetric corrective surfaces in order to correct the trapezoidal image distortion and the bow-like image distortion that is caused by oblique projection because the projection surface is cylindrical.

The at least two corrective optical surfaces simultaneously correct the bow-like image distortion and the trapezoidal image distortion as they are moved away from the Y-Z cross section in the positive direction and the negative direction of the X-axis to change the angle of the surfaces.

The bow-like image distortion arises as the image position in the Y coordinate changes both positively and negatively in the direction of the X-axis and it is important for the inclination of the surface (angle) to change in order to correct the distortion. The trapezoidal image distortion arises as the image in the direction of the X-axis is reduced in the positive region of the Y-axis and the image in the direction of the X-axis is increased in the negative region of the Y-axis. It is preferable to expand the rays in the X-direction by negative power in the direction of the X-axis in the positive region of the Y-axis and by positive power in the direction of the X-axis in the negative region of the Y-axis in order to correct the trapezoidal image distortion. Both this image distortion and the bow-like image distortion can be corrected by a same surface profile but it is difficult to correct the two image distortions by means of a single surface simultaneously. In this embodiment, two surfaces are used at two different positions to successfully cancel the two distortions.

There are provided at least two corrective optical surfaces for correcting the rays oppositely toward the positive direction and the negative direction of the Y-axis as they are moved away from the Y-Z cross section respectively in the positive direction and the negative direction of the X-axis from the Y-Z cross section in order to simultaneously correct the two image distortions including the bow-like image distortion and the trapezoidal image distortion.

The bow-like image distortion and the trapezoidal image distortion are corrected by changing the inclination of the surfaces in the Y-Z cross section as the surfaces are moved away from the origin respectively in the positive direction and the negative direction of the X-axis to shift the rays above and below. To correct the two image distortions simultaneously, it is necessary to increase the distance between the two corrective surfaces and make the distortions arise in opposite directions so as to cancel each other.

Additionally, the at least two corrective optical surfaces give a C8 term (x²y term) when the corrective optical surfaces are formed by means of respective free-form surfaces defined by formula (a) represented below:

$$Z = ( {r}^{2} / R ) / [ 1 + √ \{ 1 - ( 1 + k ) {( r / R )}^{2} \} ] + {\sum }_{j = 1}^{∞} {C}_{j} {X}^{m} {Y}^{n} , \qquad ( a )$$

where R: radius of curvature at the vertex,

k: conic constant and

r=√(X²+Y²).

The C8 term is a term of z=x²y and the image distortions can be corrected by appropriately providing this term. It is more preferable to give terms of x⁴y, x²y³, . . . and so on.

More preferably, when there are two or more corrective optical surfaces for reverse trace from the projection surface, the powers of the corrective surfaces are so arranged as to be negative-positive in the Y-Z cross section. With such an arrangement, image distortions arise only to a small extent to make it possible to downsize the optical system.

The projection surface is annular in the X-Z cross section to give rise to a large trapezoidal distortion. Therefore, more preferably, a positive-negative power arrangement is realized from the projection surface side to make it close to a telecentric arrangement in order to minimize the trapezoidal distortion as much as possible and, if possible, eliminate it.

Now, examples of the projection optical system 4 of a visual display apparatus 1 according to the present invention will be described below. The parameters of arrangement of the projection optical system 4 will be listed hereinafter. The parameters of arrangement of each of the examples are obtained by tracing back the rays of light directed to the image display element 3 from the diffusion member 6 and getting to the image display element 3 by way of the image distortion correcting element 5 as illustrated in FIG. 21.

The coordinate system of each of the examples has the origin O on the decentered optical surface of the decentered optical system at the intersection O of the first surface 6a of the diffusion member 6 and the central main ray of light 102 and the upward direction rising from the origin O and from the drawing is defined to be the positive direction of the Y-axis while the rightward direction from the origin O on the drawing is defined to be the positive direction of the Z-axis and the plane of FIG. 21 is defined to be the Y-Z plane. The X-axis for forming the right hand orthogonal coordinate system with the Y-axis and the Z-axis is defined to be in the positive direction.

The description given earlier for the decentered surface of Examples 1 through 4 also applies here. Additionally, if a specific surface and the succeeding surface of the optically acting surfaces of the optical system of each of the examples form a coaxial optical system the surface interval is given. Otherwise, the radius of curvature of each of the surfaces, the refractive index of the medium and the Abbe number are given according to the customary practice.

The shape of the free-form surface that is employed for the purpose of the present invention is defined by the formula (a) as in Examples 1 through 4. Note that the Z-axis of the definition formula operates as the axis of the free-form surface.

Also note that all the terms relating to any non-spherical surface for which no data is described in the parameters of arrangement that will be described hereinafter are equal to 0. The refractive indexes and the Abbe numbers that correspond to the d line (wavelength: 587.56 nm) are listed. The unit of length is mm. The decentration of each surface is expressed by the quantity of decentration from a reference surface as described above.

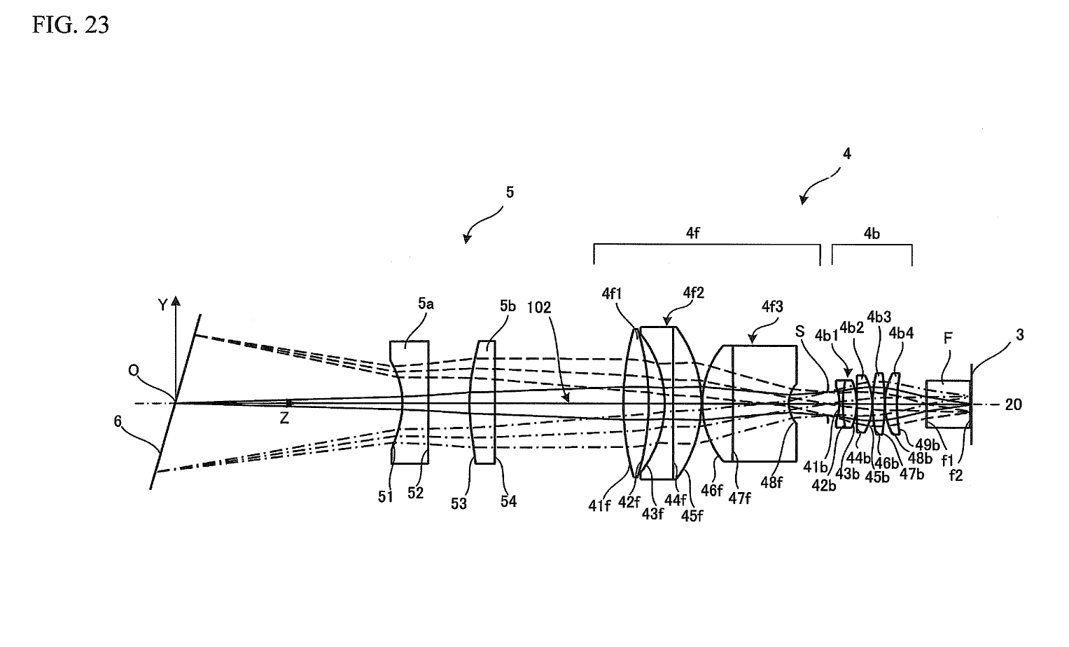

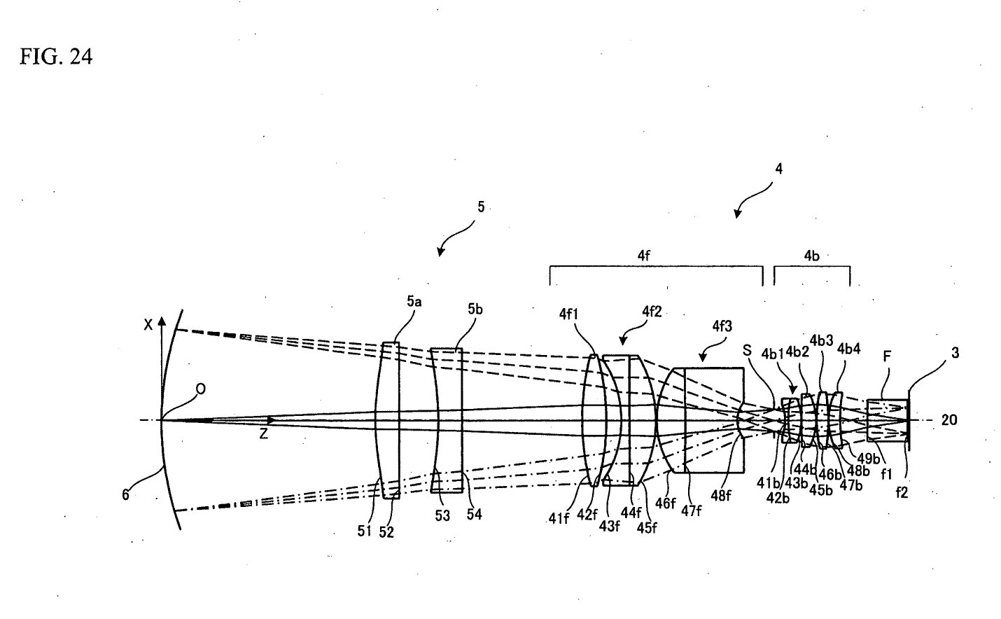

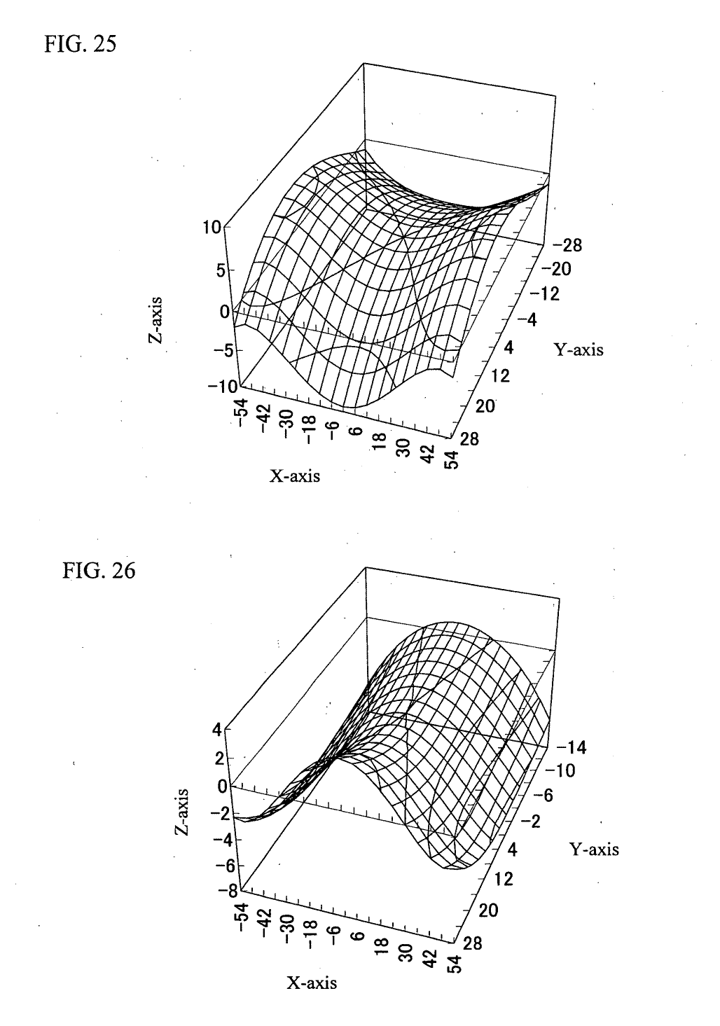

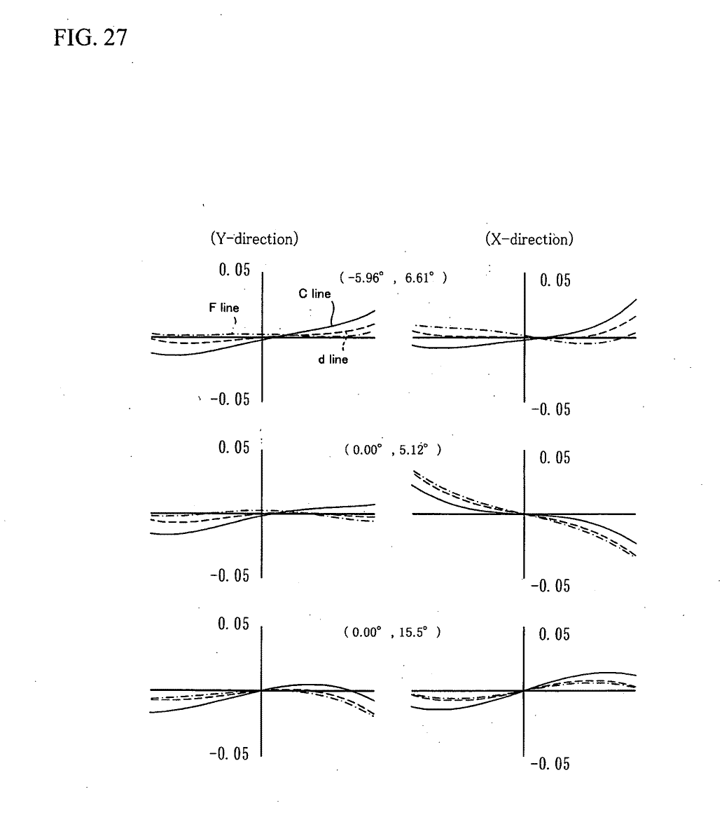

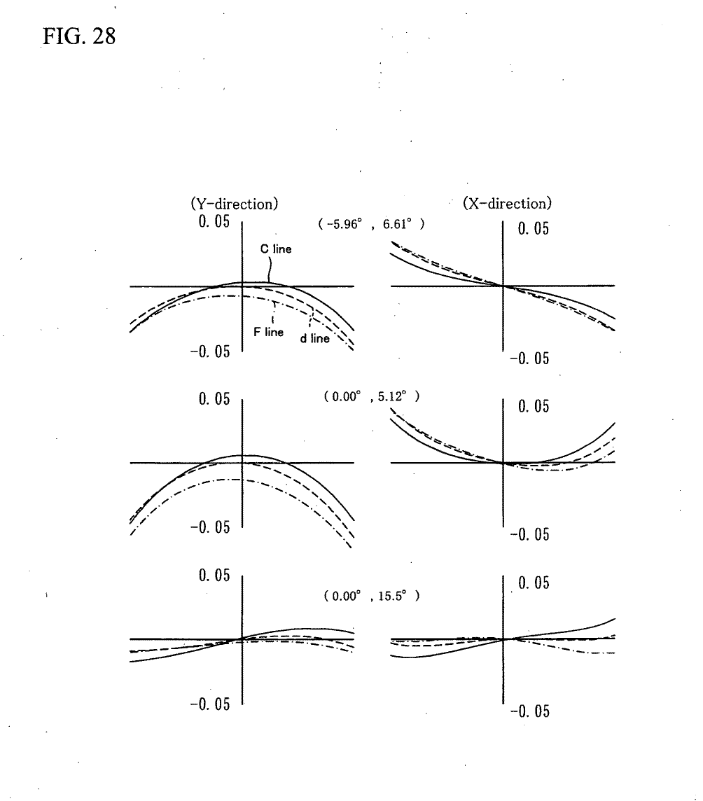

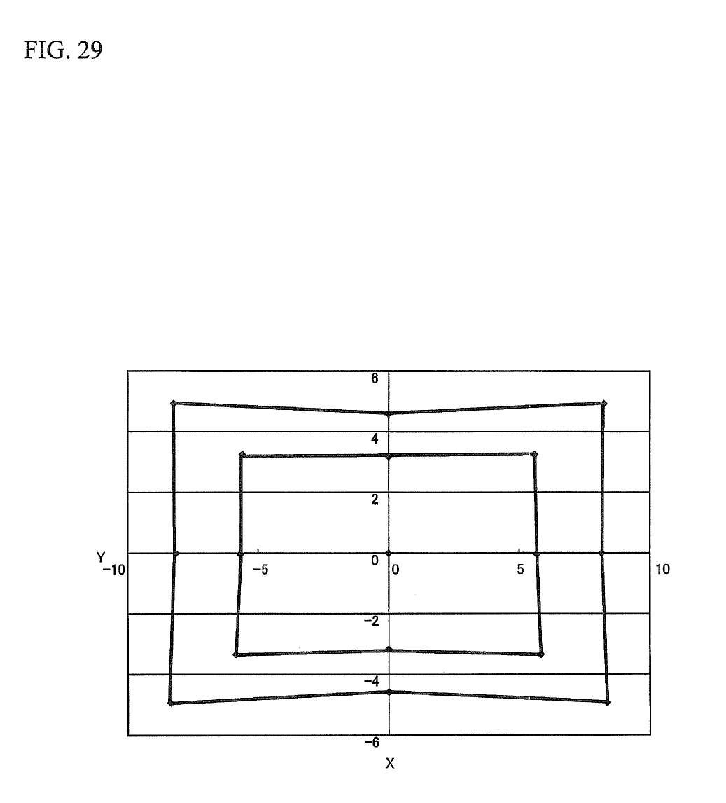

FIG. 23 is a schematic cross-sectional view of the image display element 3, the projection optical system 4, the image distortion correcting element 5 and the diffusion member 6 of Example 5 taken along the central axis 20 of the projection optical system 4. FIG. 24 is a schematic plan view corresponding to FIG. 23. Note that the eyepiece optical system 7 is not illustrated in FIGS. 23 and 24. FIG. 25 is a schematic illustration of the free-form surface of the first surface 51 of the first image distortion correcting element 5a of Example 5. FIG. 26 is a schematic illustration of the free-form surface of the first surface 53 of the second image distortion correcting element 5b of Example 5. FIGS. 27 and 28 are schematic illustrations of the aberrations of Example 5. FIG. 29 is a schematic illustration of the image distortion of Example 5.

The visual display apparatus 1 of Example 5 includes an image display element 3, a projection optical system 4 for projecting the image displayed on the image display element 3, a diffusion member 6 arranged near the image projected by the projection optical system 4 and an eyepiece optical system 7 (not illustrated) having positive reflection power for a remote virtual image that is the image projected by the projection optical system 4. The image projected by the eyepiece optical system 7, the diffusion member 6 and the projection optical system 4 is arranged so as to draw a circular arc at an arbitrary position in a plane orthogonal relative to the common axis of rotational symmetry 2. The image distortion correcting element 5 of this example corrects the bow-like image distortion of the virtual image to be observed by the eyepiece optical system 7.

Additionally, the display surface and the projection surface are tilted and decentered so as to form an angle in the Y-Z cross section and at least two rotationally asymmetric corrective optical surfaces are provided to correct the image distortion on the projection surface.

The diffusion member 6 has the first surface 61 that is formed by a cylindrical surface. The image projected by the projection optical system 4 is projected in the form of a cylinder or a cone near the diffusion member 6.

The image distortion correcting element 5 has the first image distortion correcting element 5a and the second image distortion correcting element 5b. The first image distortion correcting element 5a has the first surface 51 that is formed by a free-form surface and the second surface 52 that is formed by a plane surface as illustrated in FIG. 25. The second image distortion correcting element 5b has the first surface 53 that is formed by a free-form surface and the second surface 54 that is formed by a plane surface as illustrated in FIG. 26.

The free from surfaces that are the two corrective optical surfaces the image distortion correcting element 5 has simultaneously correct the bow-like image distortion and the trapezoidal image distortion as they are moved away from the Y-Z cross section in the positive direction and the negative direction of the X-axis to change the angle of the surfaces.

There are provided at least two corrective optical surfaces for correcting the rays oppositely toward the positive direction and the negative direction of the Y-axis as they are moved away from the Y-Z cross section respectively in the position direction and in the negative direction of the X-axis from the Y-Z cross section in order to simultaneously correct the two image distortions including the bow-like image distortion and the trapezoidal image distortion.

The at least two corrective optical surfaces give a C8 term (x²y term) when it is formed by means of a free-form surface defined by formula (a).

The projection optical system 4 has a front group first lens 4f1 that is formed by a double convex lens, a front group second lens 4f2 that is formed by a cemented lens of a piano concave lens with the concave surface directed to the side of the diffusion member 6 and a piano convex lens with the convex surface directed to the side of the image display element 3, a front group third lens 4f3 that is formed by a cemented lens of a plano convex lens with the convex surface directed to the side of the diffusion member 6 and a plano concave lens with the concave surface directed to the side of the image display element 3, an aperture S, a rear group first lens 4b1 that is formed by a cemented lens of a double concave lens and a double convex lens, a rear group second lens 4b2 that is formed by a plano convex lens with the convex surface directed to the side of the image display element 3, a rear group third lens 4b3 that is formed by a double convex lens, a rear group forth lens 4b4 that is formed by a positive meniscus lens with the convex surface directed to the side of the diffusion member 6 and a filter F.

In reverse ray trace, as a flux of light is emitted from the diffusion member 6 where an intermediate image is formed, it enters the image distortion correcting element 5. The flux of light enters the image distortion correcting element 5 from the first surface 51 of the first image distortion correcting element 5a and exits from the second surface 52 thereof. Then, it enters from the first surface 53 of the second image distortion correcting element 5b and exits from the second surface 54 thereof. Subsequently, the flux of light enters the projection optical system 4. The flux of light that enters the projection optical system 4 passes the first surface 41f and the second surface 42f of the front group first lens 4f1, the first surface 43f, the second surface 44f and the third surface 45f of the front group second lens 4f2, the first surface 46f, the second surface 47f and the third surface 48f of the front group third lens 4f3 and the aperture S. Thereafter, the flux of light passes the first surface 41b, the second surface 42b and the third surface 43b of the rear group first lens 4b1, the first surface 44b and the second surface 45b of the rear group second lens 4b2, the first surface 46b and the second surface 47b of the rear group third lens 4b3, the first surface 48b and the second surface 49b of the rear group fourth lens 4b4 and the first surface f1 and the second surface f2 of the filter F to form an image on the image display element 3.

The specifications of this Example 5 include the following.

Angle of View:

| | |
|---|---|
| vertical | 20° |
| horizontal | 35° |

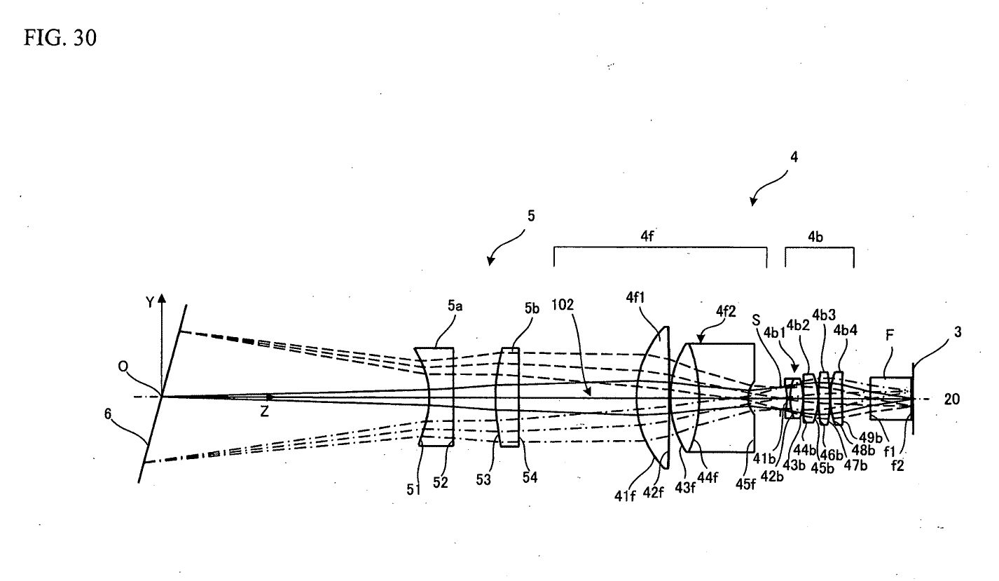

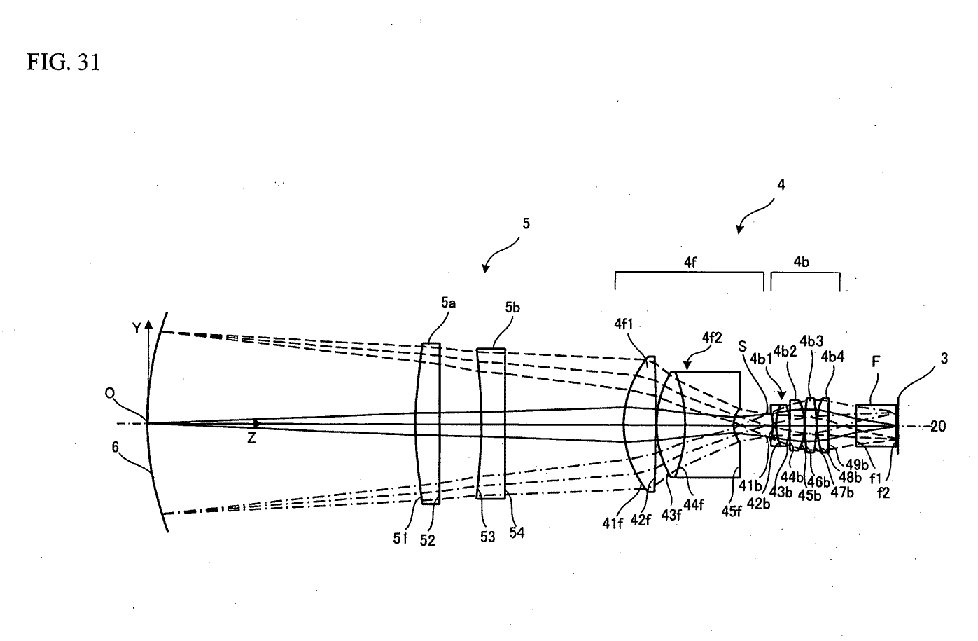

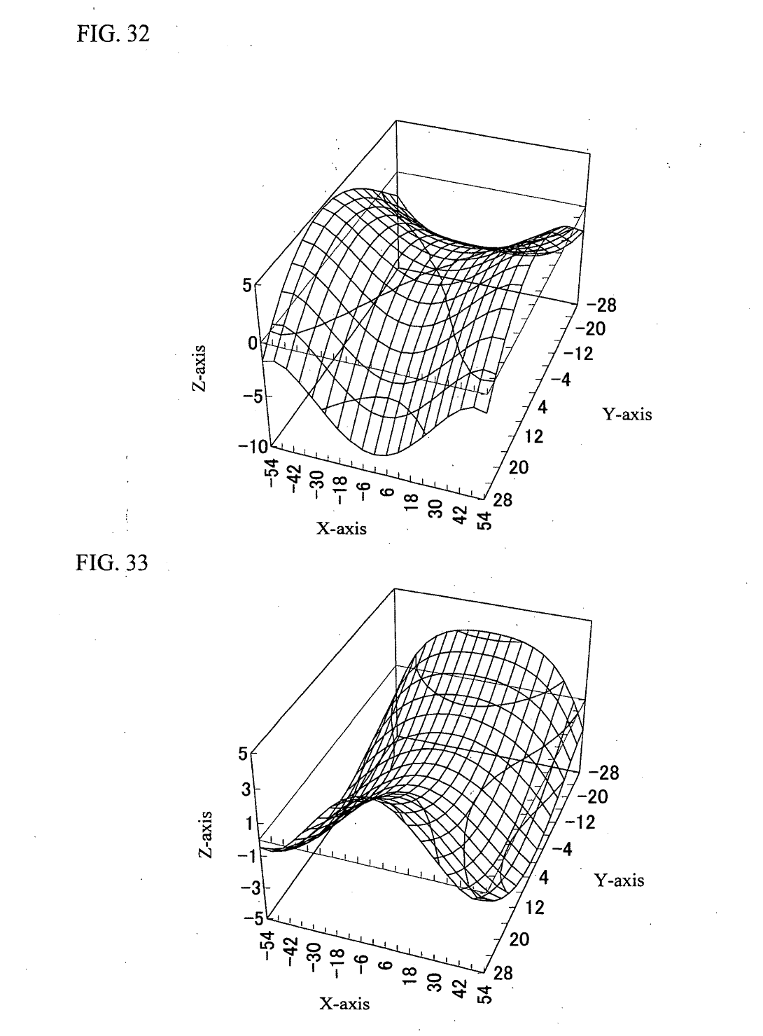

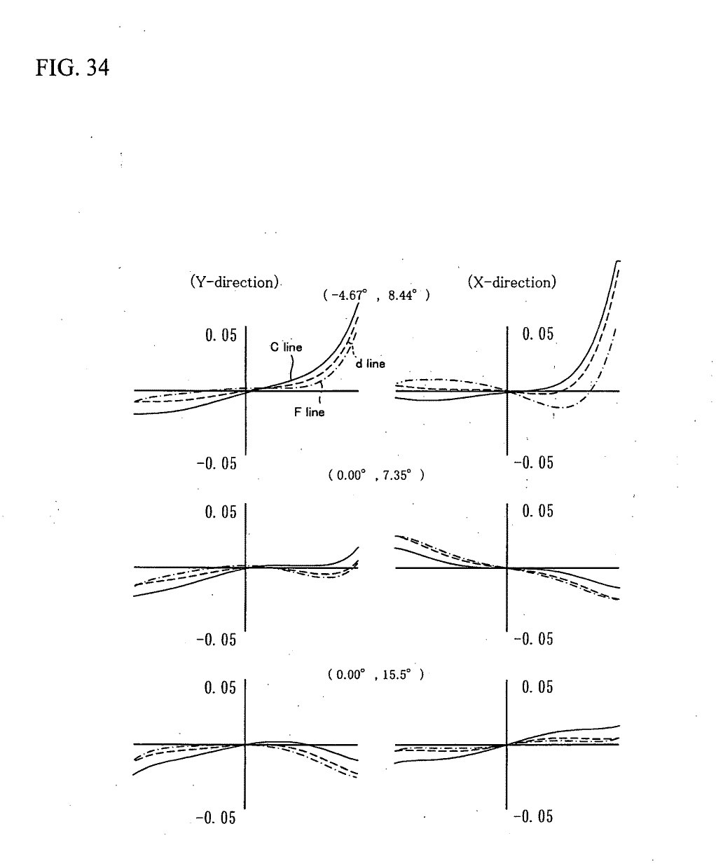

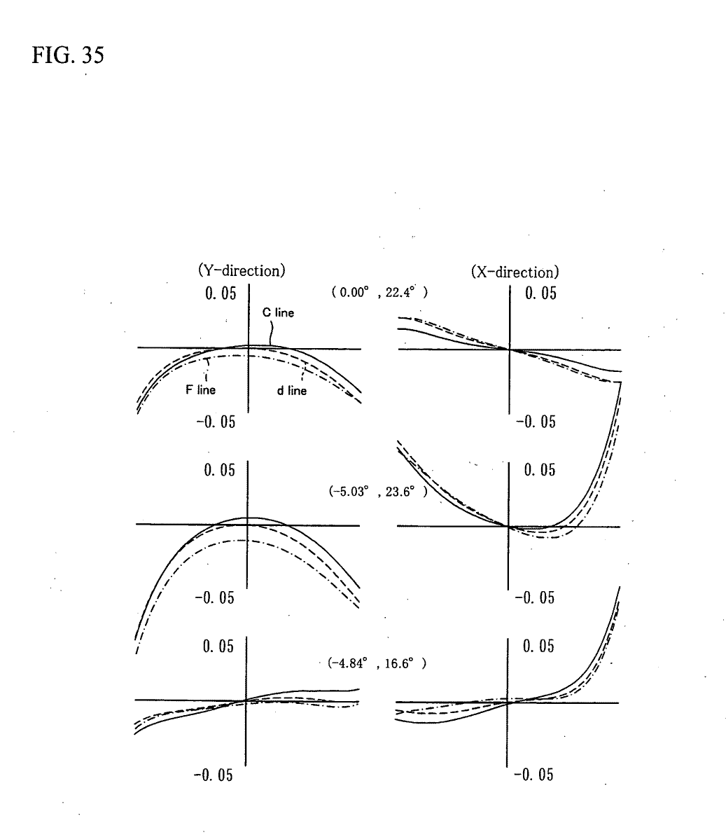

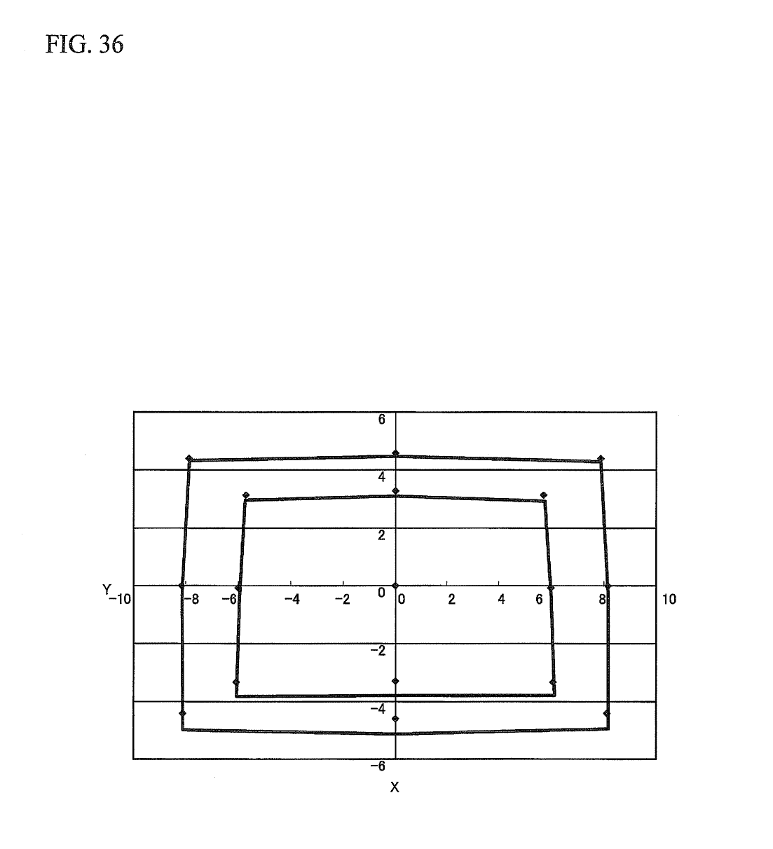

FIG. 30 is a schematic cross-sectional view of the image display element 3, the projection optical system 4, the image distortion correcting element 5 and the diffusion member 6 of the visual display apparatus 1 of Example 6 taken along the axis of rotational symmetry 42 of the projection optical system 4. FIG. 31 is a schematic plan view corresponding to FIG. 30. Note that the eyepiece optical system 7 is not illustrated in FIGS. 30 and 31. FIG. 32 is a schematic illustration of the free-form surface of the first surface 51 of the first image distortion correcting element 5a of Example 6. FIG. 33 is a schematic illustration of the free-form surface of the first surface 53 of the second image distortion correcting element 5b of Example 6. FIGS. 34 and 35 are schematic illustrations of the aberrations of Example 6. FIG. 36 is a schematic illustration of the image distortion of Example 6.

The visual display apparatus 1 of Example 6 includes an image display element 3, a projection optical system 4 for projecting the image displayed on the image display element 3, a diffusion member 6 arranged near the image projected by the projection optical system 4 and an eyepiece optical system 7 (not illustrated) having positive reflection power for a remote virtual image that is the image projected by the projection optical system 4. The image projected by the eyepiece optical system 7, the diffusion member 6 and the projection optical system 4 is arranged so as to draw a circular arc at an arbitrary position in a plane orthogonal relative to the common axis of rotational symmetry 2. The image distortion correcting element 5 of this example corrects the bow-like image distortion of the virtual image to be observed by the eyepiece optical system 7.

Additionally, the display surface and the projection surface are tilted and decentered so as to form an angle in the Y-Z cross section and at least two rotationally asymmetric corrective optical surfaces are provided to correct the image distortion on the projection surface.

The diffusion member 6 has the first surface 61 that is formed by a cylindrical surface. The image projected by the projection optical system 4 is projected in the form of a cylinder or a cone near the diffusion member 6.

The image distortion correcting element 5 has the first image distortion correcting element 5a and the second image distortion correcting element 5b. The first image distortion correcting element 5a has the first surface 51 that is formed by a free-form surface and the second surface 52 that is formed by a plane surface as illustrated in FIG. 32. The second image distortion correcting element 5b has the first surface 53 that is formed by a free-form surface and the second surface 54 that is formed by a plane surface as illustrated in FIG. 33.

The free from surfaces that are the two corrective optical surfaces the image distortion correcting element 5 has simultaneously correct the bow-like image distortion and the trapezoidal image distortion as they are moved away from the Y-Z cross section in the positive direction and the negative direction of the X-axis to change the angle of the surfaces.

There are provided at least two corrective optical surfaces for correcting the rays oppositely toward the positive direction and the negative direction of the Y-axis as they are moved away from the Y-Z cross section respectively in the position direction and in the negative direction of the X-axis in order to simultaneously correct the two image distortions including the bow-like image distortion and the trapezoidal image distortion.

The at least two corrective optical surfaces give a C8 term (x²y term) when it is formed by means of a free-form surface defined by formula (a).

The projection optical system 4 has a front group first lens 4f1 that is formed by a piano convex lens with the convex surface directed to the side of the diffusion member 6, a front group second lens 4f2 that is formed by a cemented lens of a double convex lens and a double concave lens, an aperture S, a rear group first lens 4b1 that is formed by a cemented lens of a double concave lens and a double convex lens, a rear group second lens 4b2 that is formed by a piano convex lens with the convex surface directed to the side of the image display element 3, a rear group third lens 4b3 that is formed by a double convex lens, a rear group forth lens 4b4 that is formed by a positive meniscus lens with the convex surface directed to the side of the diffusion member 6 and a filter F.

In reverse ray trace, as a flux of light is emitted from the diffusion member 6 where an intermediate image is formed, it enters the image distortion correcting element 5. The flux of light enters the image distortion correcting element 5 from the first surface 51 of the first image distortion correcting element 5a and exits from the second surface 52 thereof. Then, it enters from the first surface 53 of the second image distortion correcting element 5b and exits from the second surface 54 thereof. Subsequently, the flux of light enters the projection optical system 4. The flux of light that enters the projection optical system 4 passes the first surface 41f and the second surface 42f of the front group first lens 4f1, the first surface 43f, the second surface 44f and the third surface 45f of the front group second lens 4f2 and the aperture S. Thereafter, the flux of light passes the first surface 41b, the second surface 42b and the third surface 43b of the rear group first lens 4b1, the first surface 44b and the second surface 45b of the rear group second lens 4b2, the first surface 46b and the second surface 47b of the rear group third lens 4b3, the first surface 48b and the second surface 49b of the rear group fourth lens 4b4 and the first surface f1 and the second surface f2 of the filter F to form an image on the image display element 3.

The specifications of this Example 6 include the following.

Angle of View:

| | |
|---|---|
| vertical | 20° |
| horizontal | 35° |

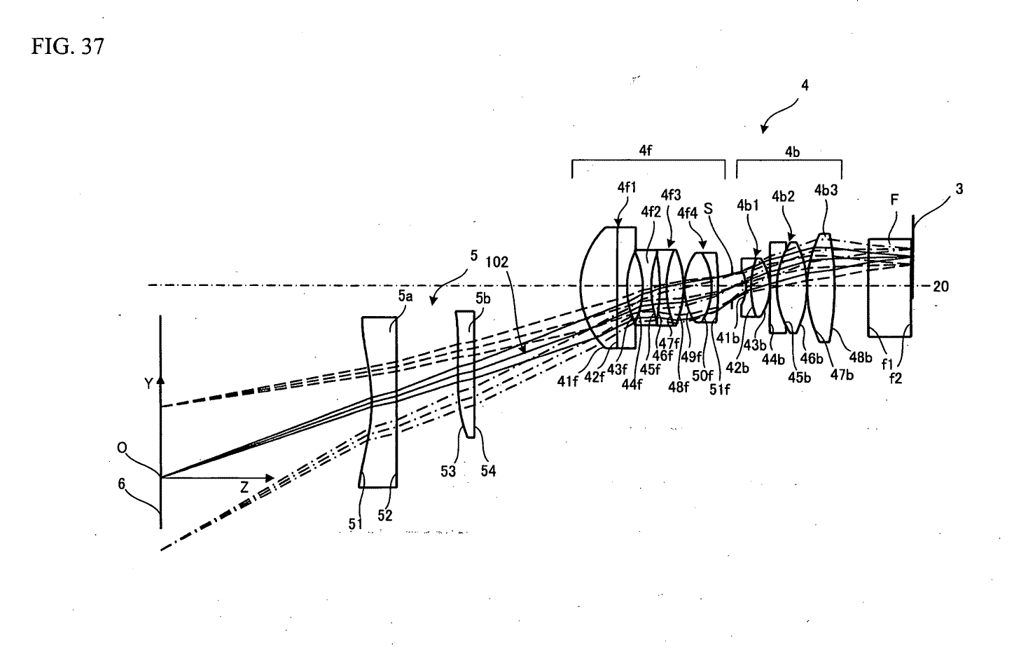

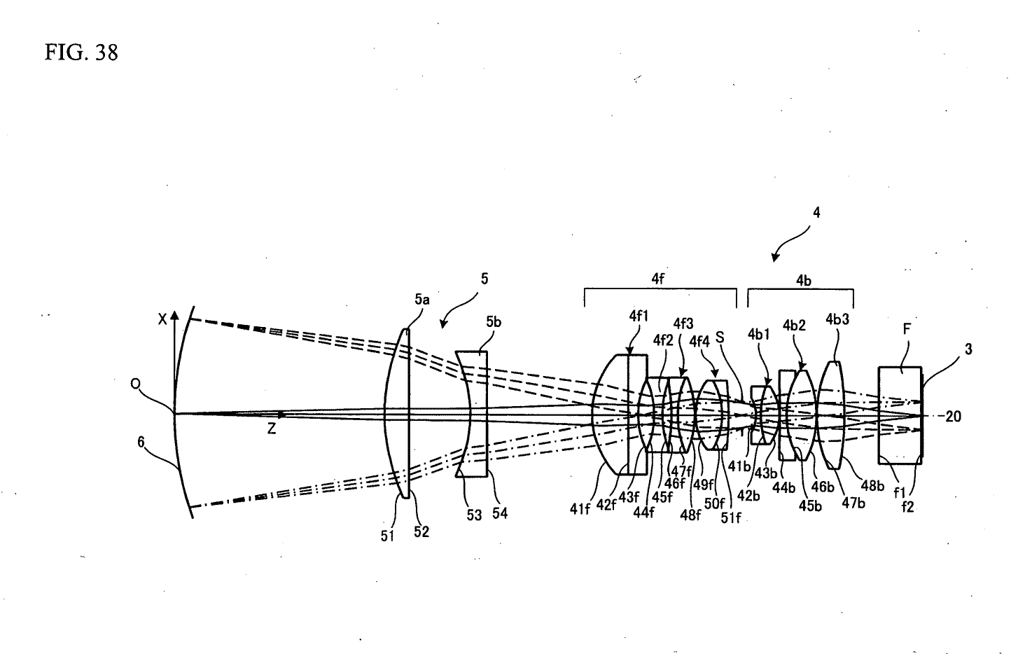

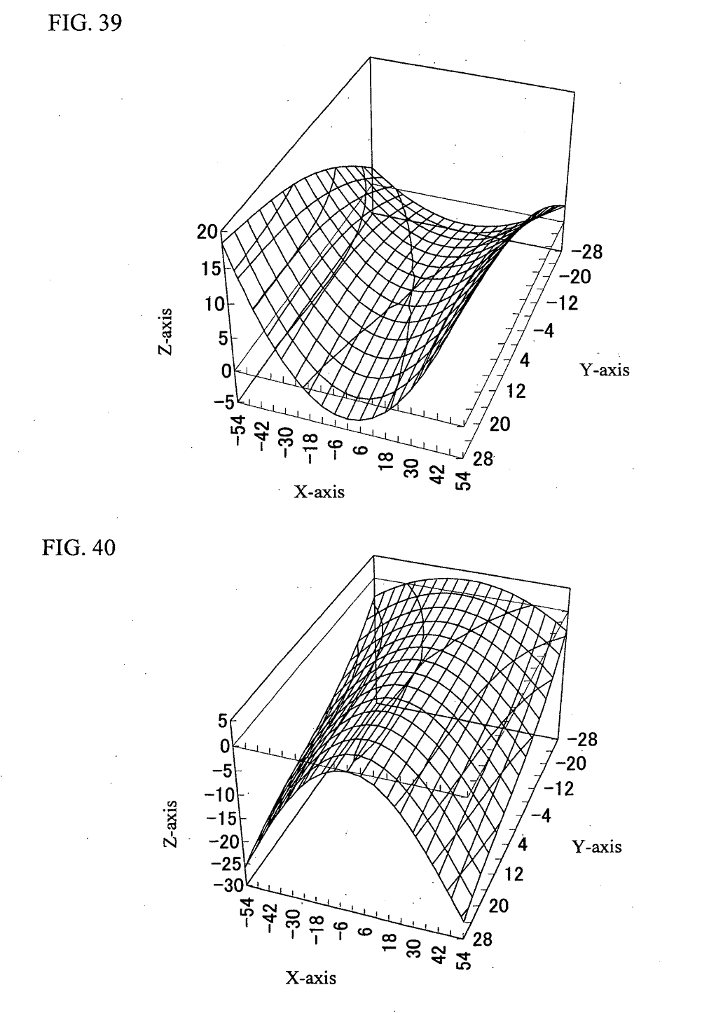

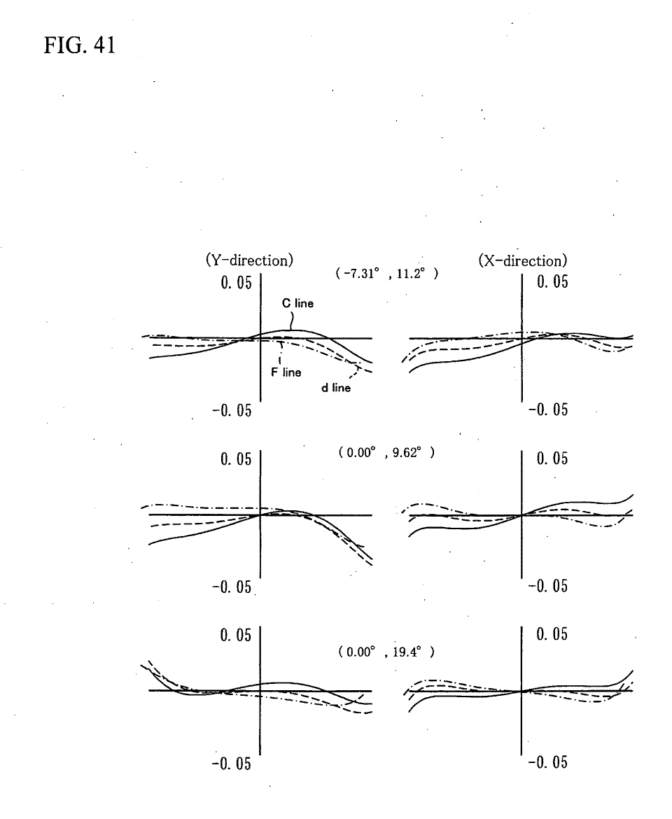

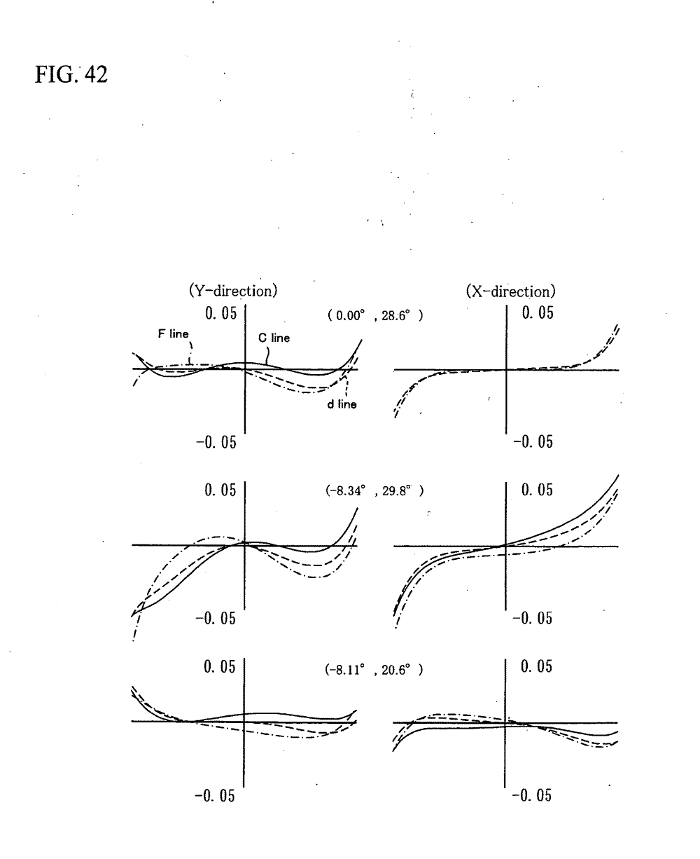

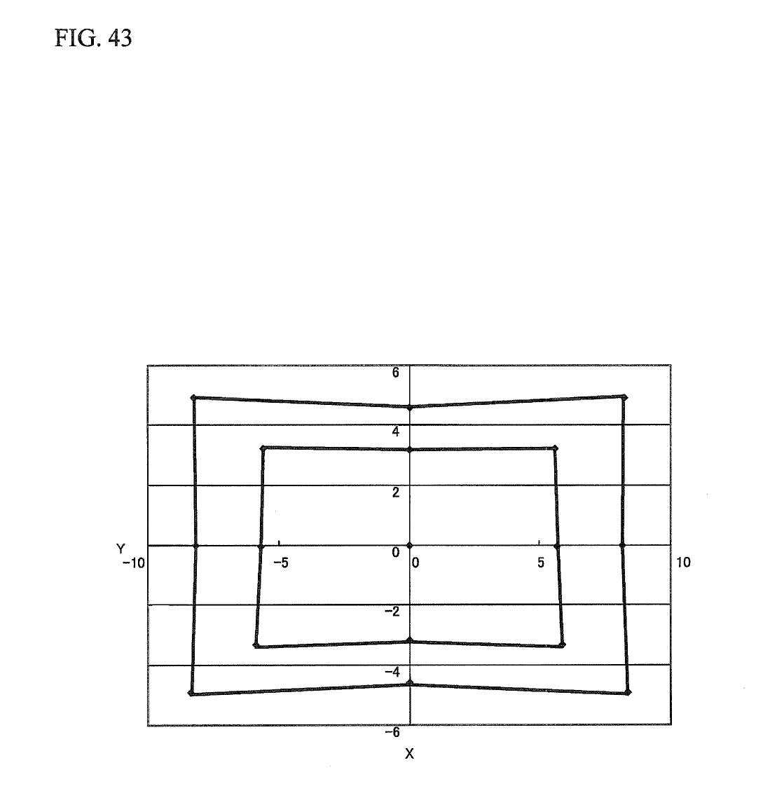

FIG. 37 is a schematic cross-sectional view of the image display element 3, the projection optical system 4, the image distortion correcting element 5 and the diffusion member 6 of the visual display apparatus 1 of Example 7 taken along the axis of rotational symmetry 42 of the projection optical system 4. FIG. 38 is a schematic plan view corresponding to FIG. 37. Note that the eyepiece optical system 7 is not illustrated in FIGS. 37 and 38. FIG. 39 is a schematic illustration of the free-form surface of the first surface 51 of the first image distortion correcting element 5a of Example 7. FIG. 40 is a schematic illustration of the free-form surface of the first surface 53 of the second image distortion correcting element 5b of Example 7. FIGS. 41 and 42 are schematic illustrations of the aberrations of Example 7. FIG. 43 is a schematic illustration of the image distortion of Example 7.

The visual display apparatus 1 of Example 7 includes an image display element 3, a projection optical system 4 for projecting the image displayed on the image display element 3, a diffusion member 6 arranged near the image projected by the projection optical system 4 and an eyepiece optical system 7 (not illustrated) having positive reflection power for a remote virtual image that is the image projected by the projection optical system 4. The image projected by the eyepiece optical system 7, the diffusion member 6 and the projection optical system 4 is arranged so as to draw a circular arc at an arbitrary position in a plane orthogonal relative to the common axis of rotational symmetry 2. The image distortion correcting element 5 of this example corrects the bow-like image distortion of the virtual image to be observed by the eyepiece optical system 7.

Additionally, the display surface and the projection surface are shifted in parallel and decentered in the Y-Z cross section and the corrective optical surface of the image distortion correcting element 5 corrects the bow-like image distortion that arises because the projection surface to which a flux of light is projected obliquely in the Y-Z cross section is cylindrical.

The diffusion member 6 has the first surface 61 that is formed by a cylindrical surface. The image projected by the projection optical system 4 is projected in the form of a cylinder or a cone near the diffusion member 6.

The image distortion correcting element 5 has the first image distortion correcting element 5a and the second image distortion correcting element 5b. The first image distortion correcting element 5a has the first surface 51 that is formed by a free-form surface and the second surface 52 that is formed by a plane surface as illustrated in FIG. 39. The second image distortion correcting element 5b has the first surface 53 that is formed by a free-form surface and the second surface 54 that is formed by a plane surface as illustrated in FIG. 40.

The angle of the free-form surfaces that are the corrective optical surfaces the image distortion correcting element 5 has changes symmetrically as they are moved away from the Y-Z cross section in the positive direction and the negative direction of the X-axis.

Additionally, the free-form surfaces that are the corrective optical surfaces of the image distortion correcting element 5 turn rays of light to the side opposite to the central axis of the projection optical system 4 as they are moved away from the Y-Z cross section in the positive direction and the negative direction of the X-axis and correct the bow-like image distortion that arises with the chord thereof facing the side of the central axis 20 of the projection optical system 4 and the circular arc facing the side opposite to the central axis of the projection optical system 4 in the X-Y plane.

The corrective optical surfaces that are the corrective optical surfaces of the image distortion correcting element 5 give a C8 term (x²y term) when it is formed by means of a free-form surface defined by formula (a).

The projection optical system 4 has a front group first lens 4f1 that is formed by a cemented lens of a piano convex lens with the convex surface directed to the side of the diffusion member 6 and a piano concave lens with the concave surface directed to the side of the image display element 3, a front group second lens 4f2 that is formed by a double concave lens, a front group third lens 4f3 that is formed by a cemented lens of a double concave lens and a double convex lens, a front group fourth lens 4f4 that is formed by a cemented lens of a double convex lens and a negative meniscus lens with the convex surface directed to the side of the image display element 3, an aperture S, a rear group first lens 4b1 that is formed by a cemented lens of a double concave lens and a double convex lens, a rear group second lens 4b2 that is formed by a cemented lens of a double concave lens and a double convex lens, a rear group third lens 4b3 that is formed by a double convex lens and a filter F.

In reverse ray trace, as a flux of light is emitted from the diffusion member 6 where an intermediate image is formed, it enters the image distortion correcting element 5. The flux of light enters the image distortion correcting element 5 from the first surface 51 of the first image distortion correcting element 5a and exits from the second surface 52 thereof. Then, it enters from the first surface 53 of the second image distortion correcting element 5b and exits from the second surface 54 thereof. Subsequently, the flux of light enters the projection optical system 4. The flux of light that enters the projection optical system 4 passes the first surface 41f, the second surface 42f and the third surface 43f of the front group first lens 4fa, the first surface 44f and the second surface 45f of the front group second lens 4f2, the first surface 46f, the second surface 47f and the third surface 48f of the front group third lens 4f3, the first surface 49f, the second surface 50f and the third surface 51f of the front group fourth lens 4f4 and the aperture S. Thereafter, the flux of light passes the first surface 41b, the second surface 42b and the third surface 43b of the rear group first lens 4b1, the first surface 44b, the second surface 45b and the third surface 46b of the rear group second lens 4b2, the first surface 47b and the second surface 48b of the rear group third lens 4b3, and the first surface f1 and the second surface f2 of the filter F to form an image on the image display element 3.

The specifications of this Example 7 include the following.

Angle of View:

| | |
|---|---|
| vertical | 20° |
| horizontal | 35° |

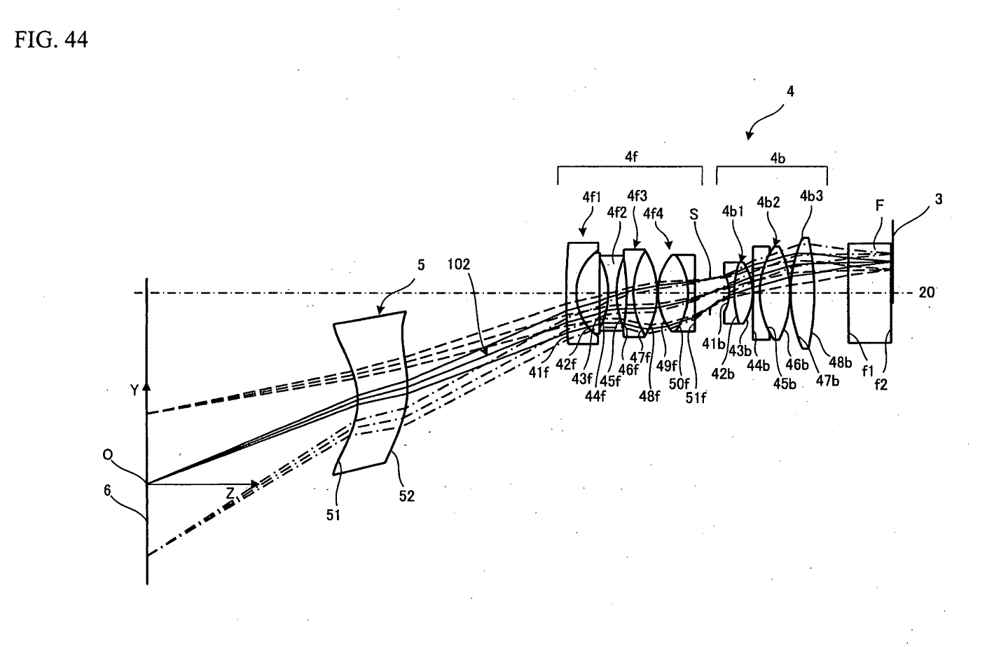

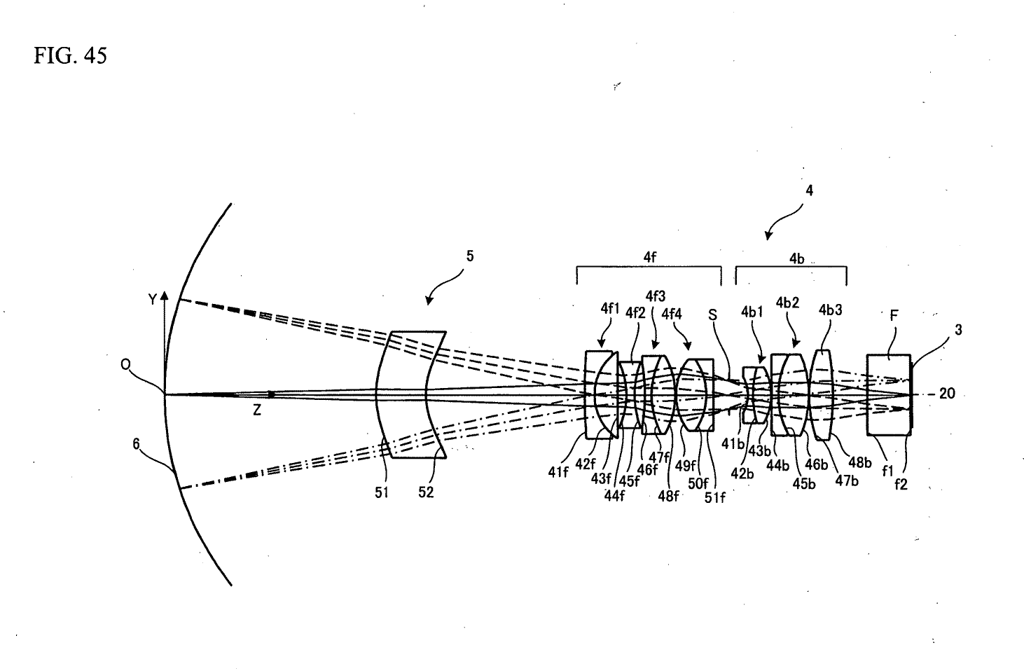

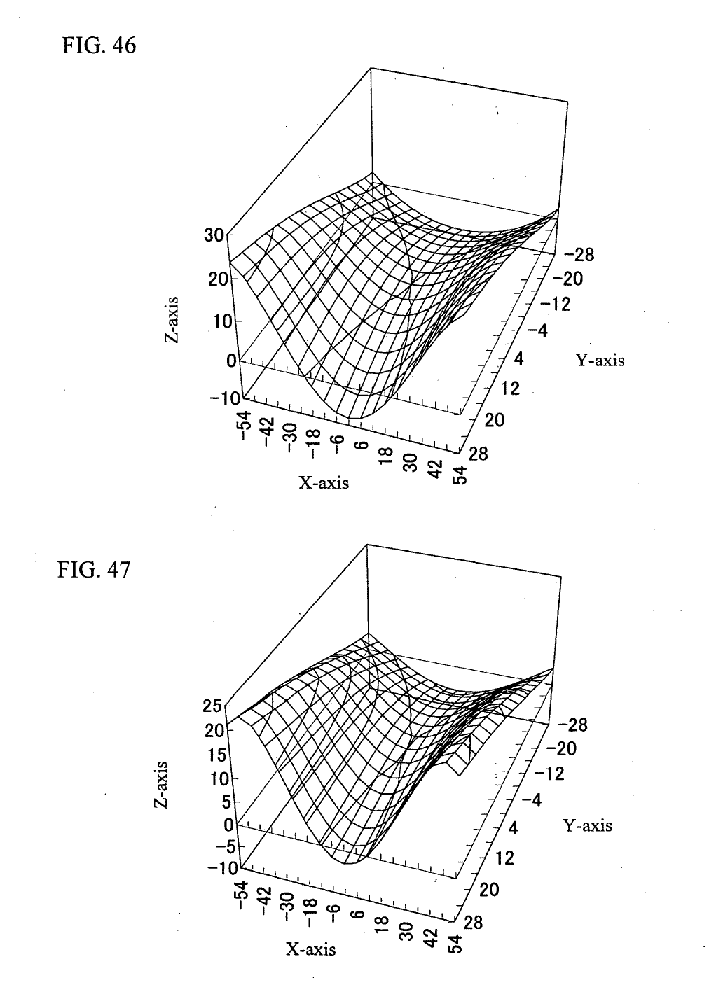

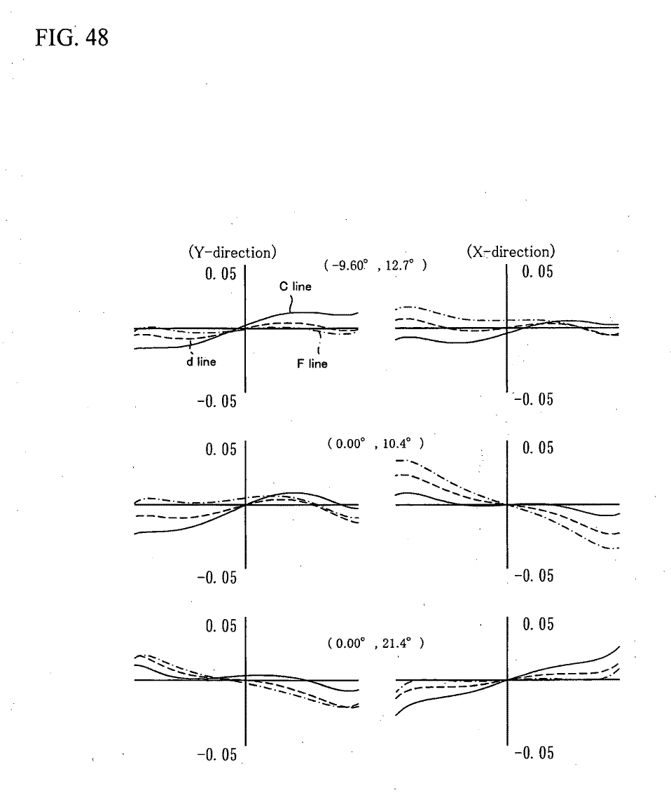

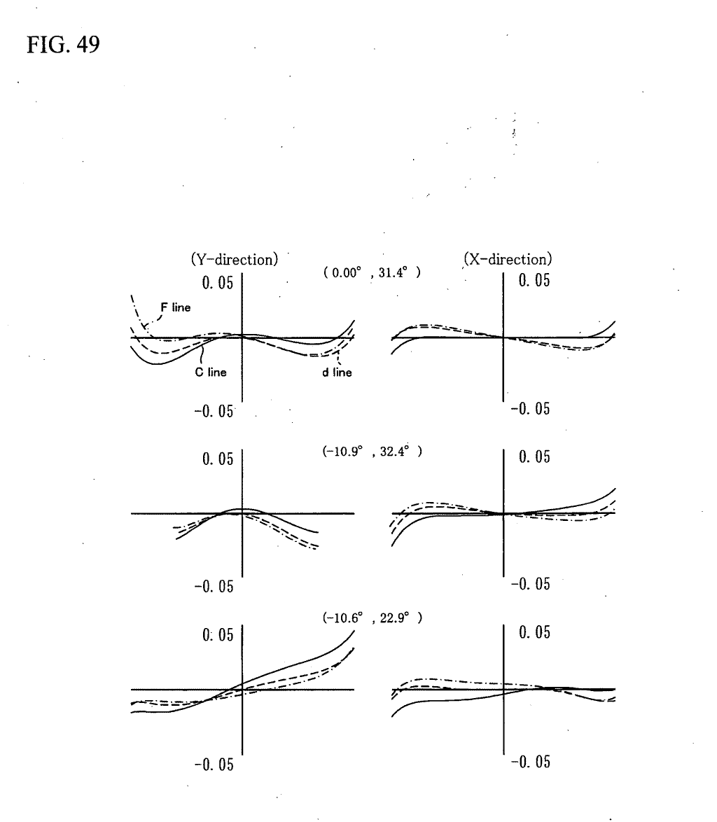

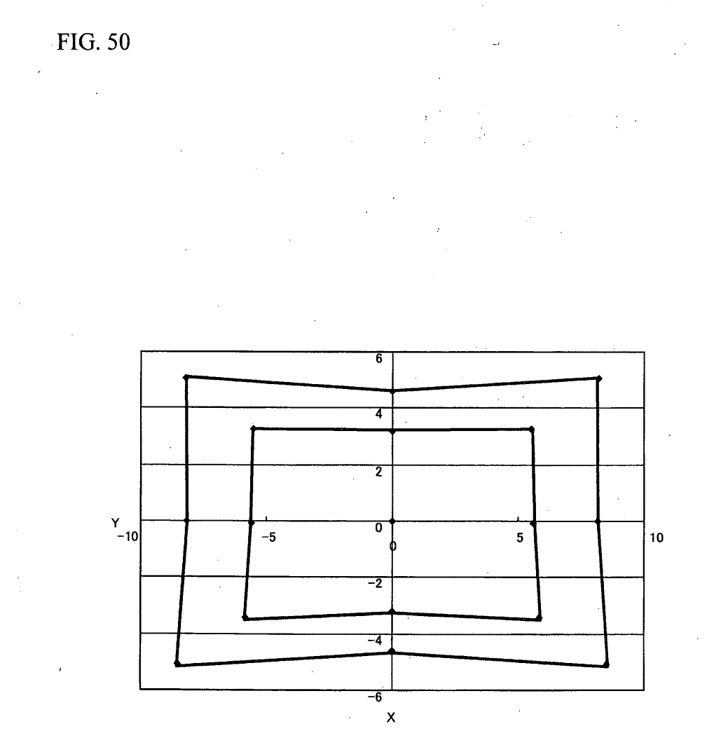

FIG. 44 is a schematic cross-sectional view of the image display element 3, the projection optical system 4, the image distortion correcting element 5 and the diffusion member 6 of the visual display apparatus 1 of Example 8 taken along the axis of rotational symmetry 42 of the projection optical system 4. FIG. 45 is a schematic plan view corresponding to FIG. 44. Note that the eyepiece optical system 7 is not illustrated in FIGS. 44 and 45. FIG. 46 is a schematic illustration of the free-form surface of the first surface 51 (not illustrated?) of the image distortion correcting element 5 of Example 8. FIG. 47 is a schematic illustration of the free-form surface of the second surface 52 (not illustrated?) of the image distortion correcting element 5 of Example 8. FIGS. 48 and 49 are schematic illustrations of the aberrations of Example 8. FIG. 50 is a schematic illustration of the image distortion of Example 8.

The visual display apparatus 1 of Example 8 includes an image display element 3, a projection optical system 4 for projecting the image displayed on the image display element 3, a diffusion member 6 arranged near the image projected by the projection optical system 4 and an eyepiece optical system 7 (not illustrated) having positive reflection power for a remote virtual image that is the image projected by the projection optical system 4. The image projected by the eyepiece optical system 7, the diffusion member 6 and the projection optical system 4 is arranged so as to draw a circular arc at an arbitrary position in a plane orthogonal relative to the common axis of rotational symmetry 2. The image distortion correcting element 5 of this example corrects the bow-like image distortion of the virtual image to be observed by the eyepiece optical system 7.

Additionally, the display surface and the projection surface are shifted in parallel and decentered in the Y-Z cross section and the corrective optical surface of the image distortion correcting element 5 corrects the bow-like image distortion that arises because the projection surface to which a flux of light is projected obliquely in the Y-Z cross section is cylindrical.

The diffusion member 6 has the first surface 61 that is formed by a cylindrical surface. The image projected by the projection optical system 4 is projected in the form of a cylinder or a cone near the diffusion member 6.

The image distortion correcting element 5 has the first surface 51 that is formed by a free from surface as illustrated in FIG. 46 and the second surface 52 that is formed also by a free from surface as illustrated in FIG. 47.

The angle of the free-form surfaces that are the corrective optical surfaces the image distortion correcting element 5 has changes symmetrically as they are moved away from the Y-Z cross section in the positive direction and the negative direction of the X-axis.

Additionally, the free-form surfaces that are the corrective optical surfaces of the image distortion correcting element 5 turn rays of light to the side opposite to the central axis of the projection optical system 4 as they are moved away from the Y-Z cross section in the positive direction and the negative direction of the X-axis and correct the bow-like image distortion that arises with the chord thereof facing the side of the central axis 20 of the projection optical system 4 and the circular arc facing the side opposite to the central axis of the projection optical system 4 in the X-Y plane.

The free-form surfaces that are the corrective optical surfaces of the image distortion correcting element 5 give a C8 term (x²y term) when it is formed by means of a free-form surface defined by formula (a).

The projection optical system 4 has a front group first lens 4f1 that is formed by a cemented lens of a negative meniscus lens with the convex surface directed to the side of the diffusion member 6 and a positive meniscus lens with the convex surface directed to the side of the diffusion member 6, a front group second lens 4f2 that is formed by a double concave lens, a front group third lens 4f3 that is formed by a cemented lens of a double concave lens and a double convex lens, a front group fourth lens 4f4 that is formed by a cemented lens of a double convex lens and a plano concave lens with the concave surface directed to the side of the diffusion member 6, an aperture S, a rear group first lens 4b1 that is formed by a cemented lens of a double concave lens and a double convex lens, a rear group second lens 4b2 that is formed by a piano concave lens with the concave surface directed to the side of the image display element 3 and a double convex lens, a rear group third lens 4b3 that is formed by a double convex lens and a filter F.

In reverse ray trace, as a flux of light is emitted from the diffusion member 6 where an intermediate image is formed, it enters the image distortion correcting element 5. The flux of light enters the image distortion correcting element 5 from the first surface 51 thereof and exits from the second surface 52 thereof. Subsequently, the flux of light enters the projection optical system 4. The flux of light that enters the projection optical system 4 passes the first surface 41f, the second surface 42f and the third surface 43f of the front group first lens 4f1, the first surface 44f and the second surface 45f of the front group second lens 4f2, the first surface 46f, the second surface 47f and the third surface 48f of the front group third lens 4f3, the first surface 49f, the second surface 50f and the third surface 51f of the front group fourth lens 4f4 and the aperture S. Thereafter, the flux of light passes the first surface 41b, the second surface 42b and the third surface 43b of the rear group first lens 4b1, the first surface 44b, the second surface 45b and the third surface 46b of the rear group second lens 4b2, the first surface 47b and the second surface 48b of the rear group third lens 4b3 and the first surface f1 and the second surface f2 of the filter F to form an image on the image display element 3.

The specifications of this Example 8 include the following.

Angle of View:

| | |
|---|---|
| vertical | 20° |
| horizontal | 35° |

The parameters of arrangement of Examples 5 through 8 are listed below. In the table below, “FFS” refers to free-form surface. The data relating to the eyepiece optical systems 7 are now illustrated.

What is claimed is:

1. A projection optical system for projecting an image being displayed on an image display element, comprising:
a projection surface of the projection optical system is formed by means of a circular-arc-shaped curved surface having a center line at the side of the projection optical system in an X-Z cross section; and
at least a rotationally asymmetric corrective optical surface that corrects the distortion of the image on the projection surface is provided,
wherein a display surface of the image display element and a projection surface of the projection optical system are decentered in a Y-Z cross section.

2. The projection optical system according to claim 1, wherein
the display surface and the projection surface are in parallel with each other and shifted and decentered in the Y-Z cross section, and
the corrective optical surface corrects a bow-like image distortion that arises due to the cylindrical projection surface to which a flux of light is projected obliquely in the Y-Z cross section.

3. The projection optical system according to claims 2, wherein
an angle of the corrective optical surface changes symmetrically relative to the Y-Z cross section as the corrective optical surface is moved away from the Y-Z cross section in a positive direction and in a negative direction along an X-axis.

4. The projection optical system according to claim 2, wherein
the corrective optical surface directs rays of light toward the opposite side relative to a central axis of the projection optical system as the corrective optical surface moves away from the Y-Z cross section in the positive direction and the negative direction along the X-axis to correct the bow-like image distortion that arises with a chord thereof facing the central axis side of the projection optical system and a circular arc thereof facing the opposite relative to the central axis of the projection optical system in the X-Y plane.

5. The projection optical system according to claim 3, wherein
the corrective optical surface directs rays of light toward the opposite side relative to the central axis of the projection optical system as the corrective optical surface moves away from the Y-Z cross section in the positive direction and the negative direction along the X-axis to correct the bow-like image distortion that arises with the chord thereof facing the central axis side of the projection optical system and the circular arc thereof facing the opposite relative to the central axis of the projection optical system in the X-Y plane.

6. The projection optical system according to claim 2, wherein
the corrective optical surface gives a C8 term (x²y term) when the corrective optical surface is formed by means of a free-form surface defined by formula (a) represented below:
$$Z = ( {r}^{2} / R ) / [ 1 + √ \{ 1 - ( 1 + k ) {( r / R )}^{2} \} ] + {\sum }_{j = 1}^{∞} {C}_{j} {X}^{m} {Y}^{n} , \qquad ( a )$$
where R: radius of curvature at the vertex,
k: conic constant and
r=√(X²+Y²).

7. The projection optical system according to claim 1, wherein
the display surface and the projection surface are tilted and decentered to form an angle in the Y-Z cross section and the corrective optical surface has at least two rotationally asymmetric surfaces for correcting the image distortion on the projection surface.

8. The projection optical system according to claim 7, wherein
the at least two corrective optical surfaces correct simultaneously the bow-like image distortion and a trapezoidal imaging distortion that arise when the angle between the surfaces changes as the surfaces moves away from the Y-Z cross section in the positive direction and the negative direction of the X-axis.

9. The projection optical system according to claim 7, wherein
the corrective optical surface has at least two surfaces for correcting rays of light in the opposite directions toward the positive direction and the negative direction of the Y-axis as the corrective optical surface moves away from the Y-Z surface in the positive direction and the negative direction of the X-axis to correct simultaneously the bow-like image distortion and the trapezoidal imaging distortion.

10. The projection optical system according to claim 8, wherein
the corrective optical surface has at least two surfaces for correcting rays of light in the opposite directions toward the positive direction and the negative direction of the Y-axis as the corrective optical surface moves away from the Y-Z surface in the positive direction and the negative direction of the X-axis to correct simultaneously the bow-like image distortion and the trapezoidal imaging distortion.

11. The projection optical system according to claim 7, wherein
the at least two corrective optical surfaces give a C8 term (x²y term) when the corrective optical surfaces are formed by means of respective free-form surfaces defined by formula (a) represented below:
$$Z = ( {r}^{2} / R ) / [ 1 + √ \{ 1 - ( 1 + k ) {( r / R )}^{2} \} ] + {\sum }_{j = 1}^{∞} {C}_{j} {X}^{m} {Y}^{n} , \qquad ( a )$$
where R: radius of curvature at the vertex,
k: conic constant and
r=√(X²+Y²).

12. A visual display apparatus comprising:
the projection optical system according to claim 1;
a diffusion surface arranged near the image projected by the projection optical system; and
an eyepiece optical system having positive reflection power for a remote virtual image that is the image projected by the projection optical system,
wherein, the image projected by the eyepiece optical system, the diffusion surface and the projection optical system being arranged so as to draw a circular arc at an arbitrary position in a plane orthogonal relative to the common axis of rotational symmetry.

13. The visual display apparatus according to claim 12, wherein
a conditional formula (1) represented below is satisfied:
400<R (1),
where R is the radius of curvature of a part (near a visual axis) of the eyepiece optical system that a central main ray of light from the projection optical system strikes.

14. The visual display apparatus according to claim 12, wherein
the diffusion surface is toric-surface-shaped.

15. The visual display apparatus according to claim 12, wherein
the eyepiece optical system is a spherical surface.

16. The visual display apparatus according to claim 12, wherein
the eyepiece optical system is a toric surface.

17. The visual display apparatus according to claim 12, wherein
the corrective optical surface is formed by a light transmitting element.

18. The visual display apparatus according to claim 15, wherein
the light transmitting element has a free-form surface.
